(19) United States
(12) Patent Application Publication
(10) Pub. No.: US 2024/0180672 A1
(43) Pub. Date: Jun. 6, 2024

(54) SMART ORTHODONTIC APPLIANCES WITH HIERARCHICAL STRUCTURES AND MATERIALS

(71) Applicant: Daniel LEE, San Jose, CA (US)

(72) Inventor: Daniel LEE, San Jose, CA (US)

(21) Appl. No.: 18/405,870

(22) Filed: Jan. 5, 2024

Related U.S. Application Data
(63) Continuation of application No. PCT/US2022/036122, filed on Jul. 5, 2022.
(60) Provisional application No. 63/218,232, filed on Jul. 2, 2021.

(51) Int. Cl. A61C 7/08

(52) U.S. Cl. CPC A61C 7/08

(57) ABSTRACT

This application is directed to orthodontic devices, systems, and methods for repositioning teeth. An orthodontic device includes an integral piece of orthodontic appliance, and the orthodontic appliance defines a target tooth arrangement and having at least a reinforcement portion and a shell portion. The orthodontic appliance is configured to hug a plurality of teeth and resiliently reposition the plurality of teeth from a current tooth arrangement to the target tooth arrangement gradually within an extended duration of time. The reinforcement portion has a first stiffness level extended from the reinforcement portion and has a second stiffness level, the second stiffness level lower than the first stiffness level.

### RELATED APPLICATION

This application is a continuation of International Application No. PCT/US2022/036122, titled “Smart Orthodontic Appliances with Hierarchical Structures and Materials,” filed Jul. 5, 2022, which claims priority to U.S. Provisional Patent Application No. 63/218,232, titled “Smart Orthodontic Appliances with Hierarchical Structures and Materials,” filed Jul. 2, 2021, which in incorporated by reference in its entirety.

### TECHNICAL FIELD

The present application generally relates to orthodontics, and more particularly to, orthodontic devices, systems, and methods for applying local targeted force to reposition teeth to a target tooth arrangement in an efficient manner.

### BACKGROUND

Tooth aligners (e.g., dental braces) have been widely applied to adjust tooth positions and jaw alignment gradually. Existing tooth aligners are designed according to targeted geometrical changes of patients' teeth, and a target tooth arrangement is achieved via a series of incremental steps. Orthodontists adjust dental braces to move the teeth to desirable positions macroscopically and gradually with discrete and stepwise distances and rotations. Adjustment of the dental braces highly relies on experience of the orthodontists, and an outcome and a temporal length of an orthodontic process vary significantly among different orthodontists.

Alternatively, removeable polymeric appliances have also being used with a series of incremental arrangements associated with the target arrangement. As a patient wears the polymeric appliances having the series of incremental arrangements, the patient's teeth are gradually repositioned to the target arrangement via the polymeric appliances. However, the series of incremental arrangements of the polymeric appliances are designed to prioritize geometrical results without considering force distribution, i.e., orthodontists plan macroscopic tooth movements without considering precise points of contact between appliances and teeth. Force generated by each polymeric appliance is oftentimes imprecise and random. Local force may be excessively strong or weak, and may even cancel each other in an undesirable manner, rendering random and changing contact points between appliances and teeth during the entire course of tooth repositioning. Such randomness of tooth repositioning (“entropy”) peaks as a new polymeric appliance is initially put on, and gradually decreases and settles as the teeth are forced into a designated morphological arrangement of the polymeric appliance. As such, existing tooth aligning solutions are neither efficient nor biologically optimal. It would be beneficial to have a more efficient mechanism to reposition tooth than the current practice.

### SUMMARY

This application is direct to orthodontic devices, systems, and methods for repositioning teeth. A series of orthodontic appliances are applied successively to hug teeth and reposition the teeth from an initial tooth arrangement to a final target tooth arrangement. Each orthodontic appliance includes an integral piece of orthodontic appliance, and is configured to resiliently reposition the teeth from a first tooth arrangement to a second tooth arrangement. For each orthodontic appliance, selective areas are identified to receive targeted force, and a reinforcement portion and a shell portion are formed on the orthodontic appliance to make one or more selective areas and the targeted force. The reinforcement portion has a greater stiffness level than the shell portion. Additionally, attachment structures are formed on a surface of the reinforcement portion or shell portion, and grab a surface of teeth to deliver the targeted force when the orthodontic applicant is worn by a patient. In some embodiments, the different portions associated with the selective areas and attachment structures are formed by three-dimensional printing techniques. By these means, as the series of orthodontic appliances are designed based on geometrical characteristics of the teeth, portions of each orthodontic appliance is selectively engineered to deliver targeted force, thereby facilitating and expediting teeth repositioning.

In one aspect, an orthodontic device for repositioning teeth includes an integral piece of orthodontic appliance defining a target tooth arrangement and having at least a reinforcement portion and a shell portion. The orthodontic appliance is configured to hug a plurality of teeth and resiliently reposition the plurality of teeth from a current tooth arrangement to the target tooth arrangement gradually within an extended duration of time. The reinforcement portion has a first stiffness level. The shell portion is extended from the reinforcement portion and has a second stiffness level, the second stiffness level lower than the first stiffness level.

In some embodiments, the integral piece of orthodontic appliance further includes one or more openings. Each opening is surrounded by at least one of the reinforcement portion and the shell portion, and the orthodontic appliance is configured to expose part of the plurality of teeth to an oral environment via the respective opening and allow water to circulate through the respective opening. Further, in some embodiments, the one or more openings include one or more slits or punctures formed on the shell portion, and the one or more openings are configured to modify the second stiffness level locally around the one or more openings. The one or more slits or punctures are arranged in an array. In some embodiments, the one or more openings include one or more slits or punctures formed on the reinforcement portion, and the one or more openings are configured to modify the first stiffness level locally around the one or more openings. The one or more slits or punctures are arranged in an array.

In some embodiments, the integral piece of orthodontic appliance further includes one or more slits formed on the shell portion. The one or more slits are configured to modify the second stiffness level locally around the one or more slits.

In some embodiments, the integral piece of orthodontic appliance further includes an attachment structure. The attachment structure is configured to grab a surface of a first tooth and apply a force on the surface of the first tooth along a shear direction tangent to the surface of the first tooth. The force is optionally a pull force or a push force. Further, in some embodiments, the attachment structure includes a plurality of attachment teeth on a micron level, and a surface of the plurality of attachment teeth of the attachment structures is porous on a nanometer level. In some embodiments, the attachment structure is attached to an internal surface of one of the reinforcement portion and the shell portion and configured to be in contact with a respective subset of teeth when be in contact with a respective subset of teeth when the orthodontic appliance is worn to hug the plurality of teeth. In some embodiments, the attachment structure extends from, and includes the same type of material as, a body of the reinforcement portion or the shell portion. In some embodiments, the attachment structure includes a first attachment structure, and is physically coupled to a second attachment structure via one of the reinforcement portion and the shell portion. In some embodiments, the reinforcement portion has an extended arm and the attachment structure is located at a tip area of the extended arm. In some embodiments, the attachment structure includes a first attachment structure, and the surface of the first tooth includes a first surface. The integral piece of orthodontic appliance further includes a second attachment structure configured to grab a second surface of the first tooth opposite to the first surface on the first tooth. The second attachment structure is configured to apply a second pull force on the second surface of the first tooth along a second shear direction tangent to the second surface of the first tooth, the first and second pull forces configured to rotate the first teeth gradually within the extended duration of time. In some embodiments, the attachment structure includes a first attachment structure. The integral piece of orthodontic appliance further includes a second attachment structure configured to grab a surface of a second tooth immediately adjacent to the first tooth. Both the first and second attachment structures extend from the reinforcement portion and are configured to pull the first and second teeth towards each other.

In some embodiments, the reinforcement portion and the shell portion include a first appliance material, and the reinforcement portion has a first thickness greater than a second thickness of the shell portion.

In some embodiments, the reinforcement portion includes a first appliance material, and the shell portion includes a second appliance material distinct from the first appliance material.

In some embodiments, the reinforcement portion is configured to be aligned with and come into contact with a first tooth when the orthodontic appliance is worn to hug the plurality of teeth. The reinforcement portion is located at a first position on the integral piece of orthodontic appliance. The first position and first stiffness level are configured to generate a force applied onto the first tooth, thereby facilitating repositioning of the plurality of teeth from the current tooth arrangement to the target tooth arrangement.

In some embodiments, the reinforcement portion has a first area. The shell portion has a second area that is larger than the first area, and the shell portion at least partially overlaps the reinforcement portion. Further, in some embodiments, the shell portion entirely overlaps the reinforcement portion, and the reinforcement portion is configured to be in contact with a respective subset of teeth when the orthodontic appliance is worn to hug the plurality of teeth. In some embodiments, the shell portion entirely overlaps the reinforcement portion, and the reinforcement portion is configured to be separate from the plurality of teeth by the shell portion when the orthodontic appliance is worn to hug the plurality of teeth.

In some embodiments, the reinforcement portion includes one or more of: a solid piece, a skeleton having a plurality of ribs, a frame, a grid, and a ring.

In some embodiments, a polygonal structure is attached to a surface of one of the plurality of teeth and has a plurality of receiving surfaces substantially perpendicular to the surface of the one of the plurality of teeth. The integral piece of orthodontic appliance further includes one or more attachment structures each of which is configured to grab, and apply a pull or push force on, a respective one of the plurality of receiving surfaces of the polygonal structure.

In some embodiments, the integral piece of orthodontic appliance further includes an actuator coupled to an external surface of the reinforcement or shell portion, the actuator configured to create a stimulus applied onto a subset of the plurality of teeth.

In some embodiments, the plurality of teeth includes a number of successive teeth located between two opposite end teeth. The integral piece of orthodontic appliance further includes two end portions configured to hug the two opposite end teeth, respectively, and an actuator coupled to the two end portions and configured to apply a stimulus to control relative positions of the two end portions.

In some embodiments, the integral piece of orthodontic appliance further includes a sensor. The sensor attached to an interface surface or an external surface of the orthodontic appliance and configured to monitor a characteristic of plurality of teeth.

In another aspect, a method is implemented for repositioning teeth. The method includes determining an intermediate tooth arrangement to be achieved by an orthodontic appliance based on geometrical information of a patient's teeth and providing an integral piece of orthodontic appliance. The orthodontic appliance is configured to hug a plurality of teeth and resiliently reposition the plurality of teeth from a current tooth arrangement to a target tooth arrangement gradually within an extended duration of time. Providing the integral piece of orthodontic appliance includes adjusting the intermediate tooth arrangement to the target tooth arrangement based on anatomical information of a patient's teeth, identifying a reinforcement portion and a shell portion on the target tooth arrangement based on the anatomical information of the patient's teeth, forming the reinforcement portion having a first stiffness level, and forming the shell portion extending from the reinforcement portion and having a second stiffness level, the second stiffness level lower than the first stiffness level.

In yet another aspect, a method is implemented for repositioning teeth. The method includes determining a target tooth arrangement to be achieved by an orthodontic appliance, identifying a reinforcement portion and a shell portion on the target tooth arrangement based on anatomical information of a patient's teeth, and providing an integral piece of orthodontic appliance. The orthodontic appliance is configured to hug a plurality of teeth and resiliently reposition the plurality of teeth from a current tooth arrangement to the target tooth arrangement gradually within an extended duration of time. Providing the integral piece of orthodontic appliance includes forming the reinforcement portion having a first stiffness level and forming the shell portion extending from the reinforcement portion and having a second stiffness level. The second stiffness level is lower than the first stiffness level.

### BRIEF DESCRIPTION OF DRAWINGS

The accompanying drawings, which are included to provide a further understanding of the embodiments and are incorporated herein and constitute a part of the specification, illustrate the described embodiments and together with the description serve to explain the underlying principles.

FIG. 1 is a flow diagram of an example process of repositioning teeth using a series of orthodontic appliances, in accordance with some embodiments.

FIG. 2 is an image of a row of upper teeth wearing an orthodontic appliance 202, in accordance with some embodiments.

FIG. 3 is an image of an integral piece of orthodontic appliance made based on a physical model for a row of teeth, in accordance with some embodiments.

FIG. 4 is an image showing an attachment structure of an orthodontic appliance and a microlevel cross sectional view of the attachment structure, in accordance with some embodiments.

FIG. 5 is an image showing a microlevel cross sectional view of the attachment structure and a nanolevel cross sectional view of an attachment tooth, in accordance with some embodiments.

FIG. 6 is a flow diagram of a process of forming an attachment structure of an orthodontic appliance, in accordance with some embodiments.

FIG. 7 illustrates force applied onto a tooth 208 by an attachment structure of an orthodontic appliance, in accordance with some embodiments.

FIG. 8 illustrates force patterns associated with tooth extrusion, tipping, and rotation, in accordance with some embodiments.

FIG. 9 is an example honeycomb actuator used to form a shell portion 206 of an orthodontic appliance, in accordance with some embodiments.

FIG. 10 are force configurations in a normal material, an auxetic material, and a half-auxetic material, in accordance with some embodiments.

FIG. 11 is an orthodontic appliance having a plurality of force components, in accordance with some embodiments.

FIG. 12 is an orthodontic appliance 202 hugging a plurality of teeth including a first tooth and a second tooth, in accordance with some embodiments.

FIG. 13 is an example orthodontic appliance having distinct arrangements between an reinforcement portion and a shell portion, in accordance with some embodiments.

FIG. 14 is an example orthodontic appliance having a plurality of openings, in accordance with some embodiments.

FIG. 15 is an image of a row of upper teeth wearing an orthodontic appliance having no openings, in accordance with some embodiments.

FIG. 16 illustrates two force patterns for tipping a tooth in a plane substantially parallel to a front tooth plane, in accordance with some embodiments.

FIG. 17 are two distinct cross sectional views of a tooth pushed by two force components, in accordance with some embodiments.

FIG. 18 illustrate force patterns for rotating one or two teeth, in accordance with come embodiments.

FIG. 19 illustrates force patterns for pulling a tooth along a tooth central axis 808, in accordance with come embodiments.

FIG. 20 illustrates a force pattern for moving an entirety of a tooth in a direction perpendicular to a front surface of the tooth, in accordance with come embodiments.

FIG. 21 illustrates three force patterns for opening a space between two immediately adjacent teeth, in accordance with come embodiments.

FIG. 22 illustrates three force patterns for closing a space between two immediately adjacent teeth, in accordance with come embodiments.

FIG. 23 illustrates force patterns for moving a set of immediately adjacent teeth with respect to anchorage, in accordance with come embodiments.

FIGS. 24 and 25 are perspective views of polygonal structures to be attached on a tooth for interacting with attachment structures of an orthodontic appliance, in accordance with some embodiments.

FIG. 26 illustrates six example force patterns of the attachment structures 402 of the orthodontic appliance, in accordance with some embodiments.

FIG. 27 illustrates another example force pattern of the attachment structures 402 of the orthodontic appliance, in accordance with some embodiments.

FIG. 28 is a cross sectional view of a tooth that is substantially parallel with a chewing surface of the tooth, in accordance with some embodiments.

FIG. 29 illustrates two force components having two distinct contact forms with a tooth surface (also called tooth mesh), in accordance with come embodiments.

FIG. 30 is a flow diagrams of a process for negative shape modification in digital carving, in accordance with some embodiments.

FIG. 31 illustrate three example force components produced by negative carving, in accordance with some embodiments.

FIG. 32 illustrates overfitting of an orthodontic appliance with a tooth 208, in accordance with some embodiments.

FIG. 33 illustrates two example processes of virtual shape modification, in accordance with some embodiments.

FIG. 34 illustrates vector re-direction applied to enable tooth anchorage, in accordance with some embodiments.

FIG. 35 illustrates an orthodontic appliance applied for arch expansion, in accordance with some embodiments.

FIG. 36 illustrates an orthodontic appliance coupled with one or more actuators, in accordance with some embodiments.

FIG. 37 illustrates another orthodontic appliance coupled with an actuator, in accordance with some embodiments.

FIG. 38 illustrates a set of orthodontic appliances having twin blocks, in accordance with some embodiments.

FIG. 39 illustrates a set of orthodontic appliances having a tongue blocking structure 3902, in accordance with some embodiments.

FIG. 40 illustrates an orthodontic appliance having a tongue stimulator or positioner, in accordance with some embodiments.

FIG. 41 is an example reinforcement structure created on a sheet material and applied as an reinforcement portion, in accordance with some embodiments.

FIG. 42 illustrates two rows of teeth that are coupled to one or more sensors, in accordance with some embodiments.

FIG. 43 illustrates methods for providing power to sensors and actuators applied with an orthodontic appliance, in accordance with some embodiments.

FIG. 44 is a flow diagram of a method of forming an orthodontic appliance for repositioning teeth, in accordance with some embodiments.

FIG. 45 is a flow diagram of another method of forming an orthodontic appliance for repositioning teeth, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

Various embodiments of this application are direct to orthodontic devices, systems, and methods for repositioning teeth. A series of orthodontic appliances are applied successively to reposition the teeth from an initial tooth arrangement to a final target tooth arrangement. Each orthodontic appliance includes an integral piece of orthodontic appliance having at least a reinforcement portion and a shell portion. The reinforcement portion has a greater stiffness level than the shell portion. Different portions are designed based on biological and anatomic features of a patient's teeth. For example, the reinforcement portion can create a precise force vector that acts on a crown to move a tooth from a pre-treatment position and orientation to a target orientation and position. The corresponding moving path and speed are optimized based on a physiological limit and an optimal force profile. Force vectors are created and applied on centers of rotation and centers of resistance, thereby reducing randomness of tooth movement and eliminating undesirable forces. By these means, a corresponding tooth repositioning process is driven by an efficiency of tooth movement (e.g., not excessively focused on the outcome), and can be expedited and shortened to benefit the patient.

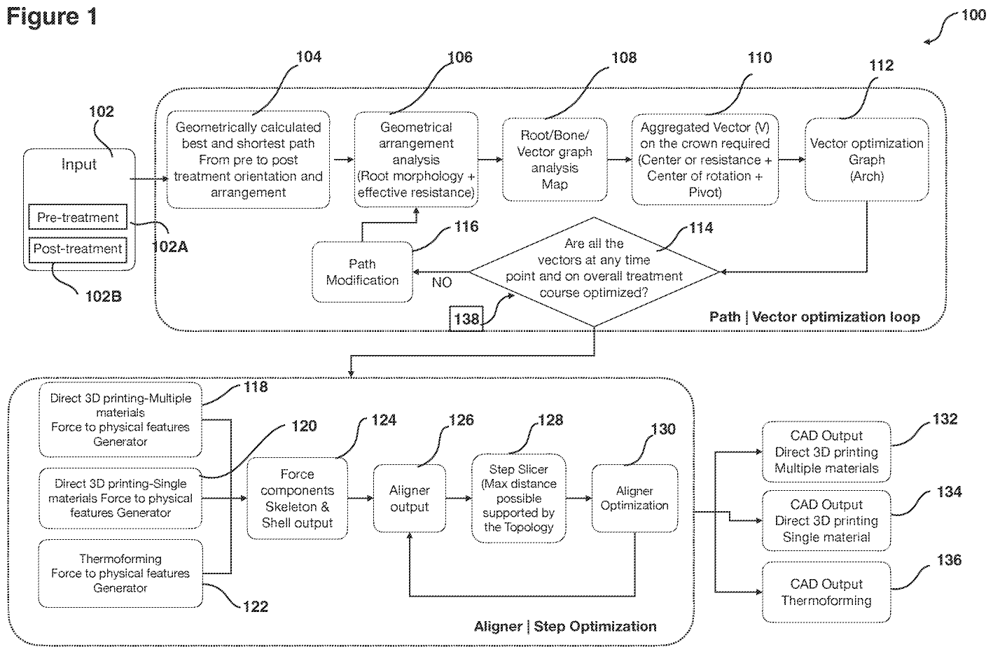

FIG. 1 is a flow diagram of an example process 100 of repositioning teeth using a series of orthodontic appliances, in accordance with some embodiments. For convenience, the process 100 is described as being implemented or controlled by a computer system. The series of orthodontic appliances are configured to be worn by a patient successively and reposition the patient's teeth from a pre-treatment tooth arrangement 102A to a post-treatment tooth arrangement 102B. An input 102 includes information of the pre-treatment tooth arrangement 102A and information of the post-treatment tooth arrangement 102B. The computer system geometrically calculates (104) a path including a plurality of geometrical arrangements from the pre-treatment tooth arrangement 102A to the post-treatment tooth arrangement 102B. The plurality of geometrical arrangements are analyzed (106) based root morphology and effective resistance of the patient's teeth to generate a graph analysis map 108 of roots, bones, and force vectors of the patient's teeth. The computer system determines (110) an aggregated force vector on a crown of a tooth based on a center of resistance, a center of rotation, and/or a pivot of the tooth, and generates a vector optimization graph 112. The computer system determines (114) whether aggregated force vectors of the plurality of teeth repositioned by the orthodontic appliances are optimized at different time points an during an overall treatment course and adjusts tooth arrangements of the series of orthodontic appliances, which is implemented iteratively in some embodiments. The path is therefore adjusted (116) to provide desirable performance for the aggregated force vectors of the plurality of teeth repositioned by the orthodontic appliances.

In some embodiments, subsequently to force optimization (114), the computer system applies one or more force to physical feature generators, e.g., a direct three-dimensional (3D) printing-multiple materials force to physical feature generator 118, a direct 3D printing-single materials force to physical features generator 120, and a thermoforming force to physical features generator 122. One or more reinforcement portions and one or more shell portions are identified (124) on each of the series of orthodontic appliances to enable the force vectors of the plurality of teeth. A series of tooth arrangements are determined (126) for the series of orthodontic appliances, and include each tooth arrangement includes the identified reinforcement portions and shell portions. The computer system determines (128) a distance limit that is permitted by the patient's teeth based on the anatomical information of the patent's teeth. Each of the series of orthodontic appliances is further adjusted (130) to provide the series of tooth arrangements customized and adjusted based on the anatomical information of the patent's teeth.

The computer system outputs, to a computer-aided design (CAD) output, the series of tooth arrangements of the series of orthodontic appliances that are customized based on the anatomical information of each patent's teeth. The output optionally includes one or more of: a direct 3D printing multiple materials output 132, a direct 3D printing single material 134, and a thermoforming output 136. In some embodiments, 3D printing is implemented to make the series of orthodontic appliances based on the direct 3D printing multiple materials output 132, and multiple materials are applied to print the reinforcement portion and shell portion of each orthodontic appliance. Alternatively, in some embodiments, 3D printing is implemented to make the series of orthodontic appliances based on the direct 3D printing single material 134, and a single material is applied with different thicknesses to form the reinforcement portion and shell portion of each orthodontic appliance. Alternatively, in some embodiments, a thermoforming process is applied to form the series of orthodontic appliances based on the thermoforming output 136.

Process 100 is, optionally, governed by instructions that are stored in a non-transitory computer readable storage medium and that are executed by one or more processors of the electronic system. Each of the operations shown in FIG. 1 may correspond to instructions stored in a computer memory or non-transitory computer readable storage medium of the computer system. The computer readable storage medium may include a magnetic or optical disk storage device, solid state storage devices such as Flash memory, or other non-volatile memory device or devices. The instructions stored on the computer readable storage medium may include one or more of source code, assembly language code, object code, or other instruction format that is interpreted by one or more processors. Some operations in process 100 may be combined and/or the order of some operations may be changed.

A moving path and speed of a patient's teeth corresponding to an orthodontic appliance are optimized based on a physiological limit and an optimal force profile 138. The physiological limit defines a bone remodeling speed, and a physiological speed limit is a scientific finding and quantified via evident-based research. The optimal force profile 138 results from scientific research and is used to move the tooth inside a bone in a desirable speed. In some embodiments, the optimal force profile 138 is provided as a primary input (f), where f is a vector that acts on a tooth root surface at any particular time point in parallel to a direction of tooth movement. In some embodiments, at any time point during the treatment course, any force value applied on any randomly sampled root surface does not exceed the optimal force profile 138 (f), which is therefore a limiting factor of the orthodontic appliance. In some embodiments, at any time point during the treatment course, any force value on any randomly sampled root surface is below and within a predefined offset from the optimal force profile 138 (f). The optimal force profile 138 (f) is affected by a bone physiology, cell activities, presence or absence of biomodulation, and other biological limitation (e.g., a force level that influences surrounding structures (buccal alveolar bone), root tip resorption).

In some embodiments, the optimal force profile 138 (f) is updated as scientific understanding of bone physiology and evident-based quantification is available. The optimal force profile 138 (f) is adjusted according to the presence or absence of any bio-modulation where the bio-modulation parameter is scientifically and conclusively quantified. In some embodiments, optimization is performed according to the following priority sequence:
At any time and orientation of the tooth, the advancing surface of the root (surface normal to the movement direction) is receiving a vector as close as possible to f (ft→f);
Aggregation of all the f on the root surface, which acts on the crown is defined as V;
Vector V (exert via the crown) is the required vector to move the tooth to from it pre-treatment O&P to its target o&p (under the constrain of f) without causing the tooth to wobble around and along; V is pure and has no noise;
The path between the pre-treatment and target teeth orientation and arrangement shall be the shortest in 3D space;
Tooth movement towards the destination shall be translated and rotated at the same time as much as possible (analogy: parallel processing); and
The vector V is translated to force that is required to be applied on the tooth surface to produce desirable V, and the optimal application point of V on the tooth surface at any particular time moment is then determined.

Tooth movement corresponds to force components. In some embodiments, a force component is generated by a physical structure that is part of an orthodontic appliance or attached to a tooth, and affects a position of one or more teeth. In some embodiments, topology of the force components of the orthodontic appliance or a change of a tooth shape produces a desirable V. In some situations, an optimal force application point on a tooth surface changes constantly as the tooth changes from an undesirable crooked position and orientation toward a target position and orientation. In some embodiments, the force vector V is affected by one or more of: biomechanical parameter, root surface area, root surface morphology, and root spatial arrangement of a tooth, and is applied according to a center of rotation, a center of resistance, and pivots. A topology of force components is affected by: the force vector V, appliance material's physical properties, and a morphological relationship of teeth in the target tooth arrangement (e.g., based on Newton's Third Law), which translates to the interplay of aligner materials.

In some embodiments, the series of orthodontic appliances are designed to reduce an entropy. A topology of the force component design aims to: (1) generate optimal vectors that acts on the optimal center of rotation and center of resistance, (2) reduce randomness by carefully align the force components and thus the vector on its optimal location, and (3) properly counteract and/or balance the force components, while taking full consideration to eliminate undesirable stray forces(vectors) and the interference due to Newton's third law. The amount of tooth movement is process-driven and results from force planning, thereby providing a more efficient tooth repositioning solution than many outcome-driven solution that design destination positions of the teeth and force the teeth to the destination positions with brute force without concerning how to move the teeth effectively and efficiently.

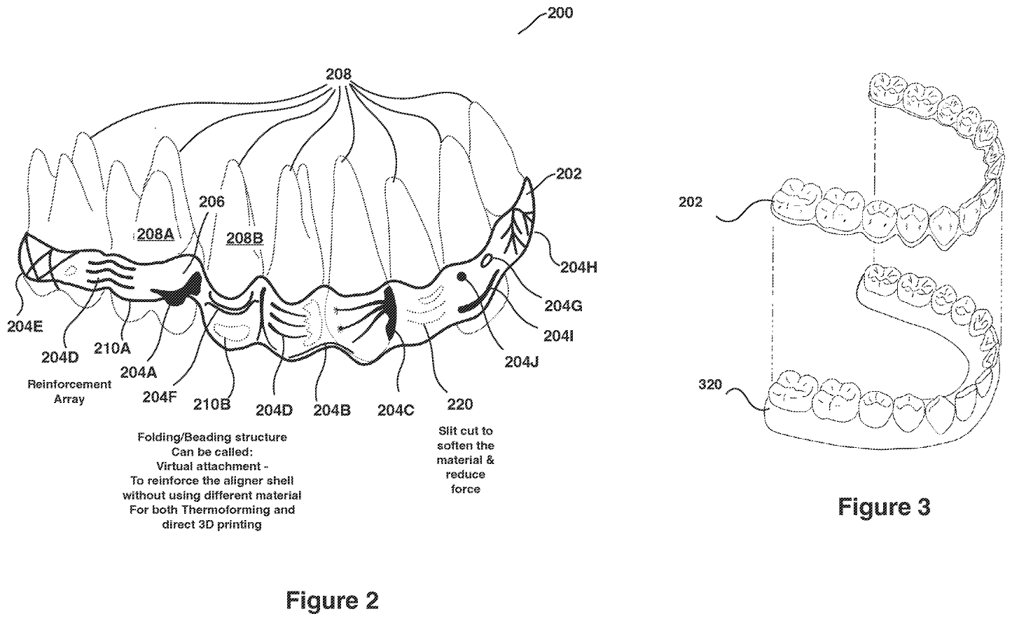

FIG. 2 is an image 200 of a row of upper teeth wearing an orthodontic appliance 202, in accordance with some embodiments. The orthodontic appliance 202 includes an integral piece of orthodontic appliance defining a target tooth arrangement and having at least a reinforcement portion 204 (also called skeleton portion) and a shell portion 206. The orthodontic appliance 202 is configured to hug a plurality of teeth 208 (e.g., the row of upper teeth in FIG. 2) and resiliently reposition the plurality of teeth 208 from a current tooth arrangement to the target tooth arrangement gradually within an extended duration of time (e.g., within 10 days). The reinforcement portion 204 has a first stiffness level. The shell portion 206 is extended from the reinforcement portion 204 and has a second stiffness level. The second stiffness level is lower than the first stiffness level. In some embodiments, the orthodontic appliance 202 is one of the series of orthodontic appliances configured to reposition the teeth 208 from an initial tooth arrangement to a final tooth arrangement. During a repositioning process, the teeth 208 pass a plurality of intermediate tooth arrangements as each of the series of orthodontic appliances (e.g., the orthodontic appliance 202) repositions the teeth 208 from the current tooth arrangement to the target tooth position.

In some embodiments, the integral piece of orthodontic appliance further includes a plurality of openings 210 (e.g., 210A, 210B). Each opening 210 is adjacent to at least one of the reinforcement portion 204 and the shell portion 206. The orthodontic appliance 202 is configured to expose part of the plurality of teeth to an oral environment via the respective opening 210 and allow water to circulate through the respective opening 210. For example, a first opening 210A is immediately adjacent to the reinforcement portion 204A and the shell portion 206 and exposes a tip of a tooth 208A. A second opening 210B is immediately adjacent to the shell portion 206 and exposes a surface of a tooth 208B. In some embodiments, a subset of openings are formed to in a grid of a shell portion or a reinforcement portion. Flexibility or strength of shell and reinforcement structures are optionally modified using cutting. In some embodiments, the openings 210 include a slit 220 or a hole. These openings 210 improve oral health by allowing circulation of saliva, eliminates occlusal interference, modify structural properties of the orthodontic appliance 202, and harness occlusal force to move teeth.

Stated another way, in some embodiments, the integral piece of orthodontic appliance 202 further includes one or more slits 220 formed on the reinforcement portion 204 or shell portion 206. The one or more slits 220 are configured to modify the second stiffness level locally around the one or more slits 220.

In some embodiments, the orthodontic appliance 202 includes a hydro-displacement structure (e.g., tree-like or track-like) with openings. The openings allow saliva to flow in and out of the hydro-displacement structure. If a space is created between the hydro-displacement structure and a corresponding tooth surface, the saliva also flows between the hydro-displacement structure and tooth surface. The hydro-displacement structure works like the car tire tread patterns. Treads allow water to escape when the car is driving on a wet road surface, thus effectively improves the contact between the tire and the road surface. Hydro-displacement structure may consist of two portions: a tooth contacting structure (tree like; track-like) and a groove or opening (tire tread equivalent) in-between the above structures. The design improves the contact of the first structure and the tooth surface by allowing the saliva to escape via the opening without pooling in between structure and the tooth surface.

In some embodiments, the reinforcement portion 204A includes a solid piece. IN some embodiments, the reinforcement portion 204B overlaps a pair of immediately adjacent teeth 208. In some embodiments, the reinforcement portion 204C has a plurality of fingers connected to a central piece, and the plurality of fingers are separated by openings 210. In some embodiments, the reinforcement portion includes a skeleton having a plurality of ribs 204D (also called an reinforcement array), a frame 204E, a grid, a beading structure 204F, a ring 204G, a tree-like structure 204H, and a bar 204I. In an example, the reinforcement portion of a solid piece has a round shape (204J) or an irregular shape (204A).

In some embodiments, as an integral piece of orthodontic appliance 202, the reinforcement portion 204 and shell portion 202 are formed in the same material or different types of materials, and cannot be separated from each other without damaging one or both of them. In some embodiments, the reinforcement portion 204 and shell portion 202 are printed jointly using 3D printing. In some embodiments, the reinforcement portion 204 and shell portion 202 are manufactured separately as two pieces and combined to the integral piece using an adhesive or using fastening structures.

FIG. 3 is an image of an integral piece of orthodontic appliance 202 made based on a physical model 320 for a row of teeth 208, in accordance with some embodiments. The orthodontic appliance 202 is formed using thermoforming based on the physical model 320. Complementary attachment structures are built in this physical model 320 to form attachment structures on the orthodontic appliance 202. In some embodiments, the integral piece of orthodontic appliance 202 is a first integral piece of orthodontic appliance 202A. The first integral piece of orthodontic appliance 202A is paired with a second integral piece of orthodontic appliance 202B. In some embodiments, each of the first integral piece of orthodontic appliance 202A and second integral piece of orthodontic appliance 202B is applied by itself, independently of each other. In some embodiments, the first integral piece of orthodontic appliance 202A and second integral piece of orthodontic appliance 202B are designed and applied jointly, such that upper and lower teeth are aligned and can bite against each other properly.

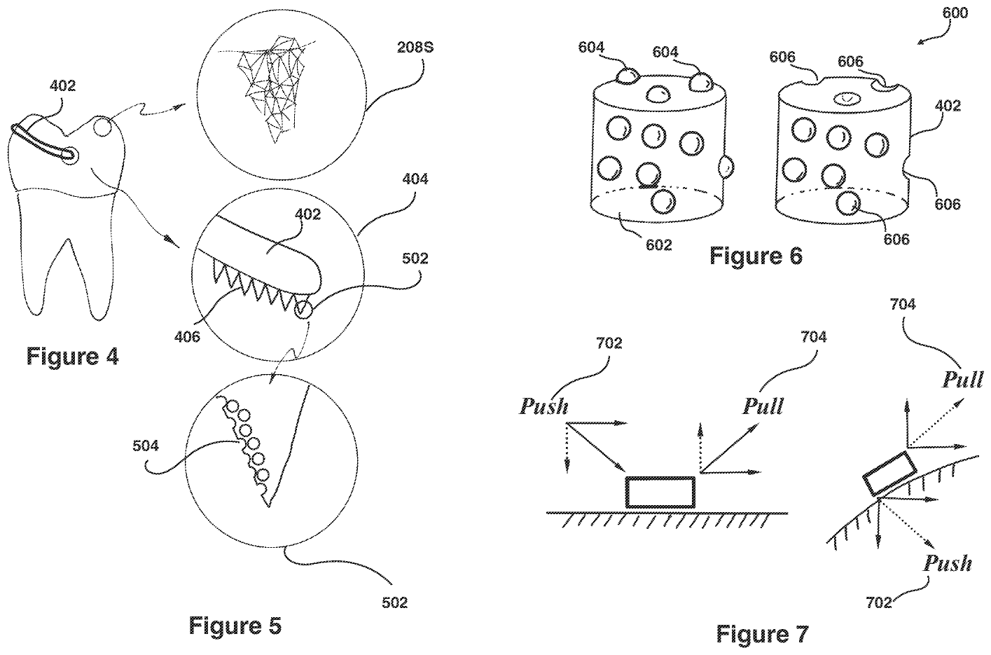

FIG. 4 is an image showing an attachment structure 402 of an orthodontic appliance 202 and a microlevel cross sectional view 404 of the attachment structure 402, in accordance with some embodiments. FIG. 5 is an image showing a microlevel cross sectional view 404 of the attachment structure 402 and a nanolevel cross sectional view 502 of an attachment tooth 406, in accordance with some embodiments. The integral piece of orthodontic appliance 202 in FIG. 2 further includes an attachment structure 402 configured to grab a surface 208S of a tooth 208 and apply a pull force on the surface 208S of the tooth 208 along a shear direction tangent to the surface 208S of the tooth 208. In some embodiments, the attachment structure 402 is attached to an internal surface of one of the reinforcement portion 204 and the shell portion 206 and configured to be in contact with a respective subset of teeth 208 when the orthodontic appliance 202 is worn to hug the plurality of teeth 208.

In some embodiments, the attachment structure 402 includes a plurality of attachment teeth 406 on a first level having a first feature size. Referring to FIG. 5, in some embodiments, a surface 504 of the plurality of attachment teeth 406 of the attachment structure 402 is porous on a second level having a second feature size. The first feature size is greater than the second feature size. For example, the attachment structure 402 includes a plurality of attachment teeth 406 on a micron level, and the surface 504 of the plurality of attachment teeth 406 has a porous structure on a nanometer level.

In some embodiments, the attachment structure 402 extends from, and includes the same type of material (e.g., a first material) as, a body of the reinforcement portion 204 or the shell portion 206. For example, in FIG. 2, the reinforcement portion 204C has an extended arm and the attachment structure 402 is located at a tip area of the extended arm. In some embodiments, the attachment structure 402 is printed using a 3D printing machine. The 3D printing machine prints the attachment structure 402 including the plurality of attachment teeth 406 and corresponding porous surface structures 504 directly. In some embodiments, the 3D printing machine prints the plurality of attachment teeth 406 and the corresponding porous structures 504 using the first material and a second material. The second material is further dissolved using a solution that does not attack the first material. After the second material is dissolved, the attachment structure 402 having the attachment teeth 406 and porous surface structures 504 is formed.

Stated another way, in some embodiments, the attachment structure 402 applied by the orthodontic appliance 202 imitates a gecko adhesive system on macro, meso, micro, and/or nanostructure levels. A contact area of the orthodontic appliance 320 with a tooth corresponds to a setal area of a gecko's toe tip. The setal area of the gecko's toe tip includes 1 million foot hairs, and each foot hair has 1000 spatular tips.

FIG. 6 is a flow diagram of a process 600 of forming an attachment structure 402 of an orthodontic appliance, in accordance with some embodiments. A material 602 that is configured to contact a tooth surface is manufactured to include dissolvable nano particles 604. The nano-particle infused material 602 is layered with the shell material for thermo forming or printed directly with direct 3D printing technology. After thermoforming or 3D printing, the exposed nano-particles 604 are removed using chemical or physical means to expose nano-pits 606 previously occupied by the nano-particles 606, thereby forming the attachment structure 402.

FIG. 7 illustrates force applied onto a tooth 208 by an attachment structure 402 of an orthodontic appliance 202, in accordance with some embodiments. Each attachment structure 402 is configured to be attached to a respective location of a tooth 208 and provide a targeted force at the respective force location of the tooth 208. The targeted force is optionally a push force 702 or a pull force 704. The pull force 704 is applied tangentially on a curved tooth surface corresponding to the respective force location of the tooth 208. The push force 702 is applied vertically onto a curved tooth surface corresponding to the respective force location of the tooth 208.

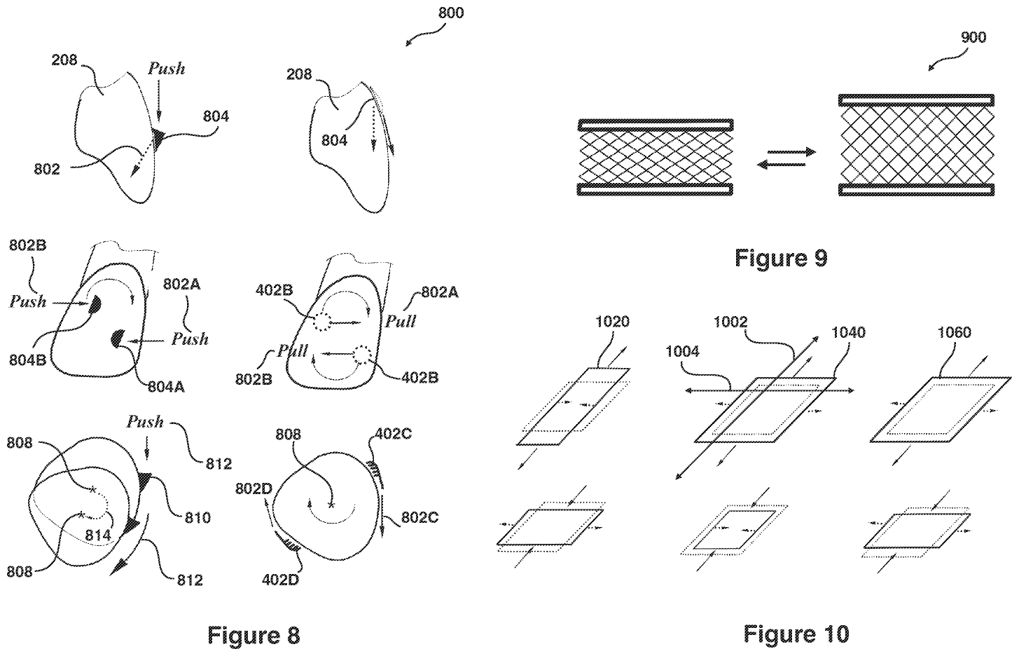

FIG. 8 illustrates force patterns 800 associated with tooth extrusion, tipping, and rotation, in accordance with some embodiments. A force 802 is intended to be applied on a tooth. In some embodiments, a protruded structure 804 is attached to a surface of a tooth to modify the tooth morphologically, e.g., using an adhesive. A surface of the protruded structure 804 is configured to receive a push force 802 applied by an orthodontic appliance 202 worn on the teeth 208. In some embodiments, the protruded structure 804 cannot be removed by manual force and has to be polished off the surface of the tooth. Alternatively, in some embodiments, an attachment structure 402 of an orthodontic appliance 202 grabs the surface of the tooth at a target location 806 and pulls the tooth to generate the force 802 when the orthodontic appliance 202 is worn by the teeth 208. The force 802 generated by the attachment structure 402 has a direction that is parallel with a tangent direction of the surface of the tooth at the target location 806. Stated another way, the target location 806 is selected according to the force 802.

A tooth is tipped substantially in a plane substantially parallel to a front tooth plane. Multiple forces are applied on the same tooth to tip the tooth, e.g., on a plane substantially parallel to a front tooth plane. In some embodiments, two protruded structures 804A and 804B are attached to a surface of a tooth at two distinct locations to modify the tooth morphologically. A respective surface of the protruded structure 804A or 804B is configured to receive a push force 802A or 802B applied by the orthodontic appliance 202 worn on the teeth 208, thereby causing the tooth to tip towards a direction of the push force 802B. Alternatively, in some embodiments, attachment structures 402A and 402B are formed on an orthodontic appliance 202. The attachment structures 402A and 402B grab the surface of the tooth at two target locations and pulls the tooth to generate two pull forces 802A and 802B, respectively, when the orthodontic appliance 202 is worn by the teeth 208. The forces 802A and 802B cause the tooth to tip towards a direction of the push force 802B. The target locations are selected to enable tipping of the tooth efficiently.

Additionally, in some embodiments, one or more forces are applied on the same tooth 208 to rotate the tooth, e.g., with respect to an tooth axis 808 passing through the tooth including its crown and root. In some embodiments, a protruded structure 810 is attached to a surface of a tooth to modify the tooth morphologically, e.g., using an adhesive. A surface of the protruded structure 810 is configured to receive a push force 812 applied by an orthodontic appliance 202 worn on the teeth 208. The push force 812 rotates (814) the tooth and shifts (814) the tooth axis 808 laterally. Alternatively, in some embodiments, attachment structures 402C and 402D are formed on an orthodontic appliance 202. The attachment structures 402C and 402D grab the surface of the tooth at two target locations and pulls the tooth to generate two pull forces 802C and 802D, respectively, when the orthodontic appliance 202 is worn by the teeth 208. The forces 802A and 802B cause the tooth to rotate with respect to the tooth axis 808. The target locations are selected to enable rotation of the tooth without causing the tooth axis 808 to shift laterally.

The orthodontic appliance 202 can work with different protruded structures 804 formed on the teeth 208 and generate push forces on the protruded structures 804. Shapes of the protruded structures 804 and resultant effective force vector are further compromised by the requirements to allow the orthodontic appliance 202 to be inserted and removed with case by the patient. Conversely, the orthodontic appliance 202 offers attachment structures 402 that grabs surfaces of the teeth 208 and apply pull actions along the tooth surface with clean and effective resultant vectors, which makes the protruded structures 804 unnecessary.

FIG. 9 is an example honeycomb actuator 900 used to form a shell portion 206 of an orthodontic appliance 202, in accordance with some embodiments. The reinforcement portion 204 acts as a skeleton structure and is configured to provide structural stability and flexibility and deliver precision and controlled forces. In some embodiments, the shell portion 206 acts as a skin or shell and is configured to provide coverage and protection to underlying structures and link structures and materials for easy human management, e.g., manually and frequently taking off and putting on the orthodontic appliance 202. In some embodiments, the shell portion 206 at least partially includes the honeycomb actuator 900 that is entirely or partially opened. This reduces a coverage of a tooth surface, thereby facilitating a saliva flow and avoiding the orthodontic appliance 202 from interfering with oral self-healing. Particularly, the honeycomb actuator 900 reduces a coverage of a tooth surface in an occlusal area, thereby reducing occlusal interface and increasing efficiency in occlusion and articulation.

In some embodiments, the shell portion 206 acts as a muscle and includes transitional or combinational of material and/or structures. For example, a material of the shell portion 206 stores a strain and is relaxed to produce a force that moves a tooth. As such, a self-actuation material (e.g., the honeycomb actuator 900) is applied to make the shell portion 206.

FIG. 10 are force configurations in a normal material 1020, an auxetic material 1040, and a half-auxetic material 1060, in accordance with some embodiments. Each of the normal material 1020, auxetic material 1040, and half-auxetic material 1060 includes a respective sheet of material and corresponds to a first in-plane direction 1002 and a second in-plane direction 1004 that is perpendicular to the first in-plane direction 1002. Both the first and second in-plane directions 1002 and 1004 are substantially parallel with a planar surface of the respective sheet of material. For the normal material 1020, when the sheet of material is stretched and has a pull force along the first in-plane direction 1002, the second in-plane direction 1004 is compressed and has a compression force; and conversely, when the sheet of material is compressed and has a compression force along the first in-plane direction 1002, the second in-plane direction 1004 is stretched and has a pull force. For the auxetic material 1040, when the sheet of material is stretched and has a first pull force along the first in-plane direction 1002, the second in-plane direction 1004 is also stretched and has a second pull force; and conversely, when the sheet of material is compressed and has a first compression force along the first in-plane direction 1002, the second in-plane direction 1004 is compressed and has a second compression force. For the half-auxetic material 1060, when the sheet of material is stretched and has a first pull force along the first in-plane direction 1002, the second in-plane direction 1004 is also stretched and has a second pull force; and conversely, when the sheet of material is compressed and has a compression force along the first in-plane direction 1002, the second in-plane direction 1004 is stretched and has a third pull force.

Each of the auxetic material 1040 and half-auxetic material 1060 acts as a respective self-actuating material. In some embodiments, during manufacturing, a first dimension of the auxetic material 1040 or half-auxetic material 1060 is made smaller than a normal size. When placed inside a patient mouth, the first dimension is expanded. Alternatively, in some embodiments, during manufacturing, a first dimension of the auxetic material 1040 or half-auxetic material 1060 is made larger than a normal size. When placed inside a patient mouth, the first dimension is compressed. For the auxetic material 1040 or half-auxetic material 1060, a resulting effect is expansion or contraction in the perpendicular direction, which creates a force to move a contact surface or an attachment structure in a desired direction.

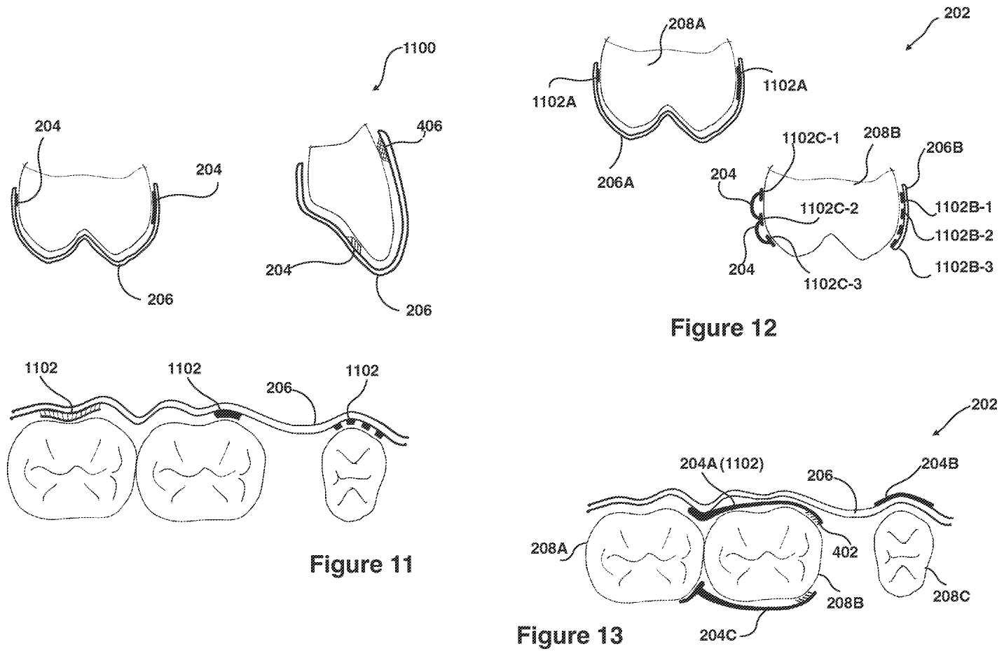

FIG. 11 is an orthodontic appliance 202 having a plurality of force components 1102, in accordance with some embodiments. In some embodiments, the reinforcement portion 204 has a first area, and the shell portion 206 has a second area that is larger than the first area. The shell portion 206 at least partially overlaps the reinforcement portion 206. Further, in some embodiments, the shell portion 206 entirely overlaps the reinforcement portion 204. The reinforcement portion 204 is configured to be in contact with a respective subset of teeth 208 when the orthodontic appliance 202 is worn to hug the plurality of teeth 208. The shell portion 206 provides an outer shell for the orthodontic appliance 202. The shell portion 206 is partially merged with the reinforcement portion 204, which optionally includes a skeleton structure that provides structural stability for the orthodontic appliance 202.

In some embodiments, the reinforcement portion 204 and the shell portion 206 include the same appliance material, and the reinforcement portion 204 has a first thickness greater than a second thickness of the shell portion 206. In some embodiments, the appliance material is substantially transparent or has a color substantially close to a color of a patient's teeth. Conversely, in some embodiments, the reinforcement portion 204 includes a first appliance material, and the shell portion includes a second appliance material distinct from the first appliance material. A thickness of the reinforcement portion 204 has a thickness greater than, equal to, or less than that of the shell portion 206, while the first stiffness level of the reinforcement portion 204 is greater than the second stiffness level of the shell portion 206. In some embodiments, each of the first and second appliance materials is substantially transparent or has a color substantially close to a color of a patient's teeth. In some embodiments, the first appliance material and a structure of the reinforcement portion 204 are selected to store a strain associated with a force to be delivered onto corresponding teeth 208.

The three force components 1102 include three reinforcement portions 204 located between the shell portion 204 and the teeth 208. Each reinforcement portion 204 is configured to be aligned with and come into contact with a respective tooth when the orthodontic appliance 202 is worn to hug the plurality of teeth 208. The respective reinforcement portion 204 is located at a first position on the integral piece of orthodontic appliance 202. The first position and first stiffness level are configured to generate a force applied onto a respective tooth, thereby facilitating repositioning of the plurality of teeth from the current tooth arrangement to the target tooth arrangement. In an example, the reinforcement portion 204A of the force component 1102A includes an array of reinforcement structures. In some embodiments, a surface of a subset of the reinforcement portions 204 in FIG. 11 has a respective attachment structure 406 configured to grab a corresponding surface of the teeth 208. In some embodiments, an internal surface of the shell portions 206 has a respective attachment structure 406 configured to grab a corresponding surface of the teeth 208.

FIG. 12 is an orthodontic appliance 202 hugging a plurality of teeth including a first tooth 208A and a second tooth 208B, in accordance with some embodiments. A shell portion 204 is used as a connector, a protective cover and a force applier in the orthodontic appliance 202. For the first tooth 208A, a corresponding shell portion 206A provides an outer shell and holds two force components 1102A in contact with the first tooth 208A. For an external surface of the second tooth 208B, a corresponding shell portion 206B provides a partial outer shell and holds three force components 1102B in contact with the second tooth 208B. Stated another way, the three force components 1102B includes a first force component 1102B-1, a second force component 1102B-2, and a third force component 1102B-3. The first force component 1102B-1 is physically coupled to the second force component 1102B-2 via part of the corresponding shell portion 206B, and the second force component 1102B-2 is physically coupled to the third force component 1102B-3 via another part of the corresponding shell portion 206B.

Conversely, for an internal surface of the second tooth 208A, three force components 1102C are held in contact with the second tooth 208B by a corresponding reinforcement portion 204. The corresponding reinforcement portion 204 connect the three force components 1102C with each other. Stated another way, the three force components 1102C includes a first force component 1102C-1, a second force component 1102C-2, and a third force component 1102C-3. The first force component 1102C-1 is physically coupled to the second force component 1102C-2 via part of the corresponding reinforcement portion 204, and the second force component 1102C-2 is physically coupled to the third force component 1102C-3 via another part of the corresponding reinforcement portion 204.

FIG. 13 is an example orthodontic appliance 202 having distinct arrangements between an reinforcement portion 204 and a shell portion 206, in accordance with some embodiments. The orthodontic appliance 1400 includes a shell portion 206 and a first reinforcement portion 204A, a second reinforcement portion 204B, and a third reinforcement portion 204C. In some embodiments, the shell portion 204 entirely overlaps the second reinforcement portion 204B, and the second reinforcement portion 204B is configured to be separate from the plurality of teeth by the shell portion 206 when the orthodontic appliance 202 is worn to hug the plurality of teeth 208.

In some embodiments, the shell portion 204 entirely overlaps the first reinforcement portion 204A. An anchor end of the first reinforcement portion 204A merges with the shell portion 206 and is configured to land on a first tooth 208A. The first reinforcement portion 204A has an extended arm. An attachment structure 402 is located at a tip area of the extended arm and configured to be in contact with a second tooth 208B immediately adjacent to the first tooth 208A. The first reinforcement portion 204A is configured to pull the second tooth 208B to the first tooth 208A. In some embodiments, the shell portion 204 does not overlap the third reinforcement portion 204C. An anchor end of the third reinforcement portion 204C is configured to land on the first tooth 208A. The third reinforcement portion 204C has an extended arm. Another attachment structure 402 is located at a tip area of the extended arm of the third reinforcement portion 204C and configured to be in contact with the second tooth 208B. The third reinforcement portion 204C is configured to pull the second tooth 208B to the first tooth 208A jointly with the first reinforcement portion 204A.

Referring to FIG. 13, in some embodiments, the shell portion 206 is applied to eliminate undesirable force exerted on teeth. The shell portion 204 does not contact the tooth surface and is physically separated from the teeth 208 by the reinforcement portion 204A or by air. The force components 1102 are in direct contact with the tooth surface at targeted tooth areas, and apply force on the targeted tooth areas with targeted orientations. Desirable force is applied without being interfered with by the shell portion 206.

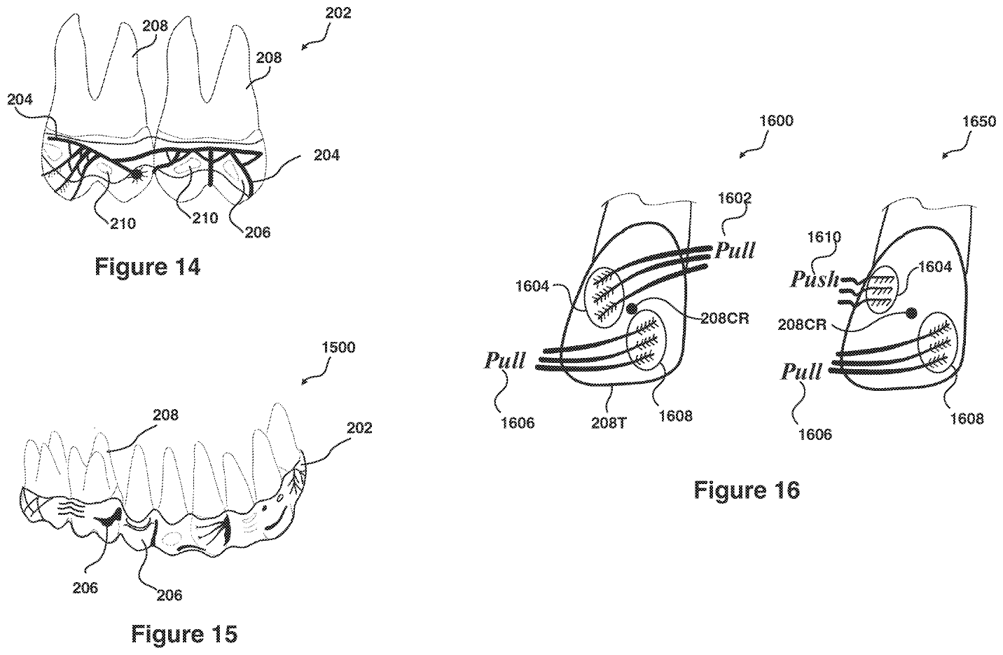

FIG. 14 is an example orthodontic appliance 202 having a plurality of openings 210, in accordance with some embodiments. The orthodontic appliance 202 has a skeleton-shell structure or an open-shell structure on a mesoscopic level. The reinforcement portion 204 includes a skeleton structure that is hard and rigid and provides structural support for the orthodontic appliance 202. The shell portion 206 is optionally in or not in contact with a surface of the teeth 208, and provides structural protection and reinforcement for the orthodontic appliance 202. Unwanted shell regions are removed to create the openings 210. The remaining shell portion 206 acts as a protection shield to avoid damage to underlying force components 1102 and as a base-support to provide reactionary force dissipation to other structures.

The remaining shell portion 206 and reinforcement portion correspond to the plurality of perforations of varying sizes in different locations. The shell portion 206 connects to the reinforcement portion 204 and/or force components (e.g., 1102 in FIG. 11) in two ways, e.g., at an anchor of an extended arm of an reinforcement portion 204A or all along a structure of the reinforcement portion 204B in FIG. 13. The openings 210 reduce tooth surface coverage and facilitate saliva flow.

FIG. 15 is an image 1500 of a row of upper teeth wearing an orthodontic appliance 202 having no openings, in accordance with some embodiments. The orthodontic appliance 202 substantially covers exposed portions of the teeth 208, and includes a plurality of force components associated with a plurality of reinforcement portions 204. In some embodiments, a plurality of shell portions 206 of the orthodontic appliance 202 are directly in contact with the teeth 208, and the plurality of reinforcement portions 204 are formed on an external surface of the plurality of shell portions 206 as the reinforced portion 204B in FIG. 13. In some embodiments, a subset or all of the plurality of shell portions 206 of the orthodontic appliance 202 are not in contact with the teeth 208, and a subset of reinforcement portions 204 are formed on an internal surface of the subset or all of the shell portions 206 as the reinforced portion 204A in FIG. 13.

A series of orthodontic appliances 202 are applied to reposition the teeth 208 from an initial tooth arrangement to a final tooth arrangement. Each of the series of orthodontic appliances 202 is independently designed, i.e., a first subset of orthodontic appliances 202 have openings 210 while a second subset of orthodontic appliances 202 do not have openings 210, independently of the first subset of orthodontic appliances 202. A first series of orthodontic appliances 202 are applied on the upper teeth concurrently with a second series of orthodontic appliances 202 applied on the lower teeth. Each orthodontic appliance 202 applied on the upper teeth has or does not have openings 110, independently of a respective orthodontic appliance 202 applied concurrently on the lower teeth. In an example, a first orthodontic appliance for the upper teeth does not have openings 210, and a second orthodontic appliance for the lower teeth has a plurality of openings 210.

FIG. 16 illustrates two force patterns 1600 and 1650 for tipping a tooth in a plane substantially parallel to a front tooth plane, in accordance with some embodiments. Multiple forces are applied on the same tooth to tip the tooth, e.g., on a plane substantially parallel to a front tooth plane. In accordance with a first force pattern 1600, one or more first parallel pull forces 1602 are applied on a first area 1604 on a first side of a tooth center 208CR, and one or more second parallel pull forces 1606 are applied on a second area 1608 on a second side of the tooth center 208CR, causing a tooth tip 208T to tip towards a direction consistent with that of the one or more second parallel pull forces 1606. In accordance with a second force pattern, one or more first parallel push forces 1610 are applied on the first area 1604 on the first side of the tooth center 208CR, while the one or more second parallel pull forces 1606 are applied on the second area 1608 on the second side of the tooth center 208CR, causing the tooth tip 208T to tip towards the direction consistent with that of the one or more second parallel pull forces 1606.

Each of the first parallel pull forces 1602, second parallel pull forces 1606, and first parallel push forces 1610 is provided by an attachment structure 402. The one or more first parallel pull forces 1602 have identical directions, and result in the same tooth motion, with the one or more first parallel push forces 1610. However, an attachment structure 402 providing a first parallel pull force 1602 extends from a first direction to reach the first area 1604, and an attachment structure 402 providing a first parallel push force 1610 extends from a second direction to reach the first area 1604. The second direction are on two opposite sides of the first area 1604.

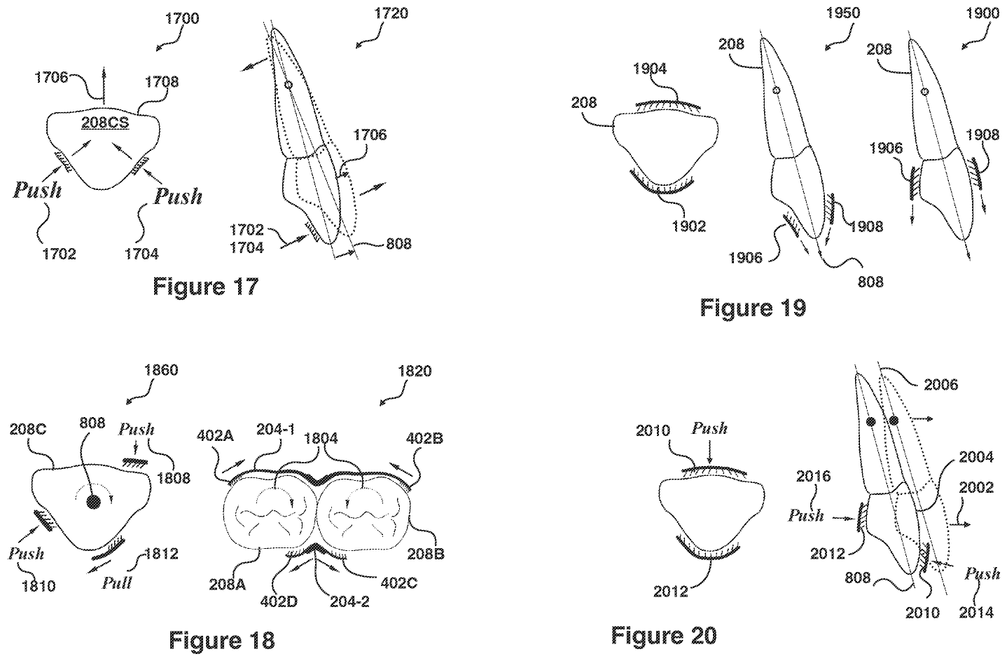

FIG. 17 are two distinct cross sectional views 1700 and 1720 of a tooth pushed by two force components 1702 and 1704, in accordance with some embodiments. As the teeth 208 wear an orthodontic appliance 202, the orthodontic appliance 202 wraps and hugs a crown of each tooth 208. The cross sectional view 1700 is captured from a plane substantially parallel to a chewing surface 208CS of a tooth. The orthodontic appliance 202 includes two force components 1702 and 1704 configured to contact the tooth from internal surfaces of the tooth. Two forces applied by the two force components 1702 and 1704 are combined and configured to generate a comprehensive force 1706 that pushes the tooth 208 outward. The comprehensive force 1706 is substantially perpendicular to a front surface 1708 of the tooth 208. In accordance with the cross sectional view 1720, the tooth 208 is pushed by the two force components 1702 and 1704 to rotate with respect a center of the tooth 208 in a root of the tooth 208, i.e., a torque is formed with respect to the center of the tooth 208 by the comprehensive force. The cross sectional view 1720 includes an tooth axis 808 and is substantially perpendicular to the front surface 1708 of the tooth 208.

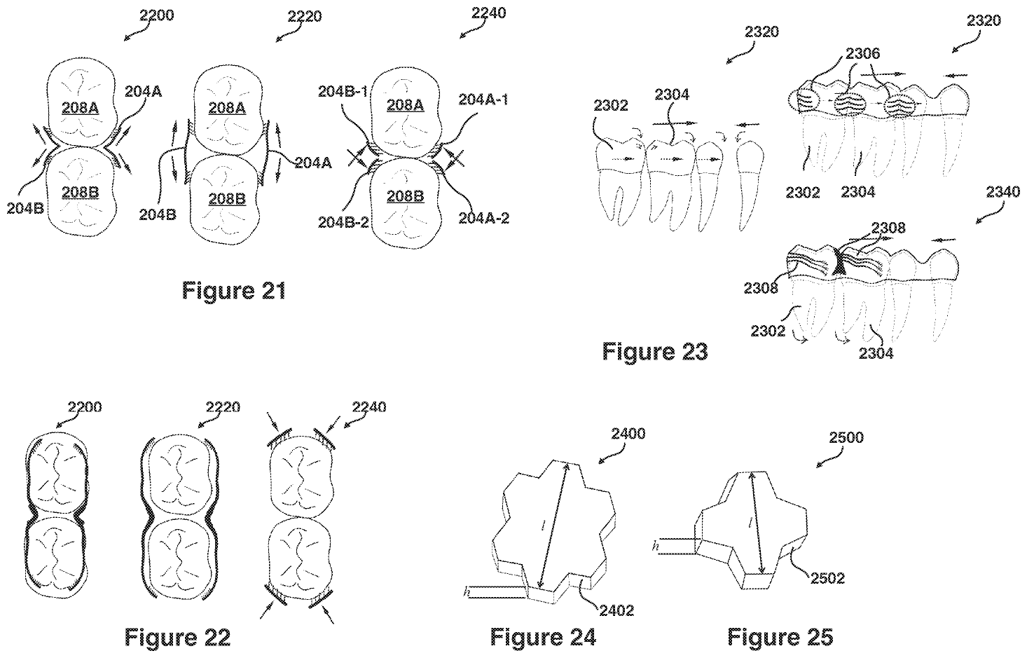

FIG. 18 illustrate force patterns 1800, 1820, 1840, and 1860 for rotating one or two teeth 208, in accordance with come embodiments. In the force pattern 1800, a first reinforcement portion 204-1 hugs the tooth from the same surface (e.g., front surfaces) of two neighboring teeth 208A and 208B. The first reinforcement portion 204-1 optionally has two ends attached to the two neighboring teeth 208A and 208B via two attachment structures 402 located at the two ends. A first attachment structure 402A grabs a surface of a first tooth 208A, and a second attachment structure 402B grabs a surface of a second tooth 208B. The first and second attachment structures 402A and 402B extend from the first reinforcement portion 204-1 and pulls the first and second teeth 208A and 208B towards each other. In some embodiments, the first and second teeth 208A and 208B are pulled to rotate towards each other. In an example, the first reinforcement portion 204-1 includes an arm connecting the first and second attachment structures 402A and 402B. Optionally, in FIG. 18, this arm is conformal to the first and second teeth 208A and 208B. Optionally, as shown in FIG. 21, the arm forms a bridge over the first and second teeth 208A and 208B, connecting the surfaces of the first and second teeth 208A and 208B.

Further, in some embodiments associated with the force pattern 1820, a second reinforcement portion 204-2 is applied, e.g., by itself, jointly with the first reinforcement portion 204-1. The second reinforcement portion 204-2 is configured to sit on surfaces that are immediately adjacent to each other on the teeth 208A and 208B. The immediately adjacent surfaces of the teeth 208A and 208B are opposite to the same surfaces to which the first reinforcement portion is disposed close. The second reinforcement portion 204-2 optionally has two attachment structures 402C and 402D attached to the immediately adjacent surfaces of the two neighboring teeth 208A and 208B. A third attachment structure 402C grabs a surface of the first tooth 208A, and a fourth attachment structure 402D grabs a surface of the second tooth 208B. The first and second attachment structures 402A and 402B extend from the second reinforcement portion 204-2 and push the first and second teeth 208A and 208B away from each other from the immediately adjacent surfaces of the two neighboring teeth 208A and 208B. In some embodiments, the first and second teeth 208A and 208B are pushed to rotate away (1804) from each other on the immediately adjacent surfaces, thereby facilitating rotation 1802 of the first and second teeth 208A and 208B towards each other on the surfaces to which the first reinforcement portion is disposed close. Each tooth 208A or 208B receives both a push force and a pull force along a respective clockwise or counter-clockwise direction. By these means, the teeth 208A and 208B are controlled to rotate with opposite directions, e.g., clockwise and counter-clockwise.

The force patterns 1840 and 1860 are observed from a chewing surface of a third tooth 208C. In the force pattern 1840, two force components 1808 and 1810 are formed from two reinforcement portions having attachment structures. Each force component 1808 or 1810 grabs a respective surface of the third tooth 208C via a respective attachment structure 402 and applies a push force on the third tooth 208C. The push forces of the force components 1808 and 1910 make the third tooth 208C to rotate with respect to a tooth central axis 808, which extends from a root to a crown of the third tooth 208C. In the force pattern 1860, a third force component 1812 is applied on the third tooth 208C in addition to the two force components 1808 and 1810. The third force component is formed from an reinforcement portion 204 that has an extended length and has an attachment structure 402 at an end. The attachment structure of the force component 1812 grabs a distinct surface of the third tooth 208C and applies a push force on the third tooth 208C to facilitate the rotation caused by the push forces of the force components 1808 and 1910 make the third tooth 208C.

FIG. 19 illustrates force patterns 1900 and 1950 for pulling a tooth 208 along a tooth central axis 808, in accordance with come embodiments. The tooth central axis 808 extends from a root to a crown of the third tooth 208. In the force pattern 1900, two force components 1902 and 1904 are formed from two reinforcement portions having attachment structures 402. The two force components 1902 and 1904 grab two opposite surfaces of the crown of the tooth 208 via respective attachment structures 402 and apply two pull forces 1906 and 1908 on the tooth 208. The two pull forces 1906 and 1908 are substantially parallel. In the force pattern 1950, locations of the two opposite surfaces of the crown of the tooth 208 are shifted towards a tip of the tooth 208. The two force components 1902 and 1904 grab the shifted locations of the two opposite surfaces of the crown of the tooth 208 via respective attachment structures 402 and apply two pull forces 1906′ and 1908′ on the tooth 208. The two opposite surfaces of the crown of the tooth 208 are not parallel at the shifted locations, nor are the two pull forces 1906′ and 1908′.

FIG. 20 illustrates a force pattern 2000 for moving an entirety of a tooth 208 in a direction 2002 perpendicular to a front surface 2004 of the tooth 208, in accordance with come embodiments. A tooth central axis 808 extends from a root to a crown of the third tooth 208, and the direction 2002 is also perpendicular to the tooth central axis 808. The tooth 208 have a pivot axis 2006 that is perpendicular to the tooth central axis 808 and parallel to the front surface 2004 of the tooth 208. The pivot axis 2006 passes a root of the tooth 208, but not a crown of the tooth 208. Two force components 2010 and 2012 are formed from two reinforcement portions 204 having attachment structures 402. The two force components 2010 and 2012 grab two opposite surfaces of the crown of the tooth 208 via respective attachment structures 402 and apply a pull force 2014 and a push force 2016 on the tooth 208, respectively.

FIG. 21 illustrates three force patterns 2100, 2120, and 2140 for opening a space between two immediately adjacent teeth 208, in accordance with come embodiments. In some embodiments associated with the force pattern 2100, the orthodontic appliance 202 includes at least one of two reinforcement portions 204A and 204B disposed on two edging areas of two immediately adjacent teeth 208A and 208B. The edging areas corresponding to each reinforcement portion 204A or 204B include a respective edging area of the tooth 208A or 208B, and the respective edging areas of the teeth 208A and 208B are immediately adjacent to each other Further, in some embodiments, one or both of two reinforcement portions 204A and 204B include attachment structures 402 configured to contact the edging areas of the teeth 208A and 208B. For each reinforcement portion 204A or 204B, forces (e.g., pull forces) are generated by the attachment structures 402 to separate the teeth 208A and 208B apart. Further, in some embodiments associated with the force pattern 2140, each reinforcement portion (e.g., 204A, 204B) is divided to two reinforcement portions (e.g., 204A-1 and 204A-2, 204B-1 and 204B-2), each of which includes an attachment structure 402 and applies a force to a tooth 208A or 208B independently.

In some embodiments associated with the force pattern 2120, the orthodontic appliance 202 includes at least one of two reinforcement portions 204A and 204B disposed on two separate areas of two immediately adjacent teeth 208A and 208B. The separate areas corresponding to each reinforcement portion 204A or 204B includes an area on the tooth 208A or another area on the tooth 208B, and the respective reinforcement portion 204A or 204B is a bridge connecting the separate areas of the teeth 208A and 208B. Further, in some embodiments, two ends of each of two reinforcement portions 204A and 204B include attachment structures 402 configured to contact the separate areas of the teeth 208A and 208B. For each reinforcement portion 204A or 204B, forces (e.g., pull forces) are generated by the attachment structures 402 to separate the teeth 208A and 208B apart. In some embodiments not shown, each reinforcement portion (e.g., 204A) is divided to two reinforcement portions, each of which includes an attachment structure and applies a force to a tooth independently.

FIG. 22 illustrates three force patterns 2200, 2220, and 2240 for closing a space between two immediately adjacent teeth 208, in accordance with come embodiments.

FIG. 23 illustrates force patterns 2300, 2320, and 2340 for moving a set of immediately adjacent teeth 208 with respect to anchorage, in accordance with come embodiments. In some embodiments, anchorage reinforcement is not applied in a force pattern 2300. Newton's law causes molars 2320 and 2304 tipping forward when the molars 2320 and 2304 are used as anchorage to move the front teeth backward. In some embodiments associated with the force pattern 2320, passive reinforcement portions 2306 make a shell portion 206 rigid in one dimension (e.g., a circumferential dimension) and prevent the molars 2320 and 2304 from tipping forward. In some embodiments associated with the force pattern 2340, active reinforcement portions 2308 and 2310 are achieved by building an anti-clockwise force tipping the molars 2320 and 2304 backward. The backward tipping force creates a “plowing-like” action that effective counter a forward tipping tendency of the molars 2320 and 2304.

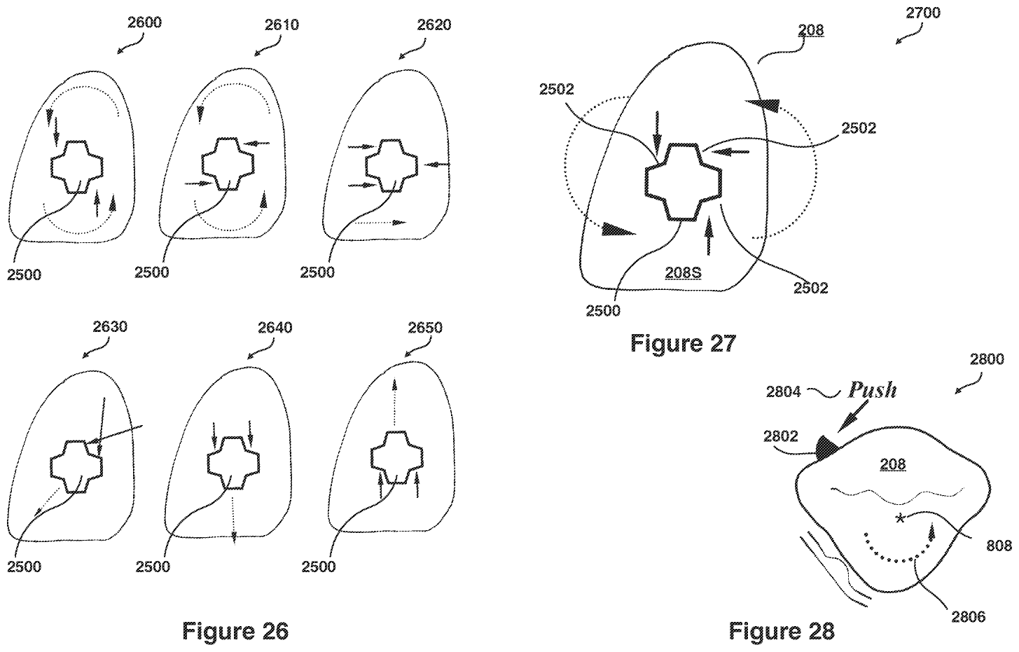

FIGS. 24 and 25 are perspective views of polygonal structures 2400 and 2500 to be attached on a tooth 208 for interacting with attachment structures 402 of an orthodontic appliance 202, in accordance with some embodiments. FIG. 26 illustrates six example force patterns 2600-2650 of the attachment structures 402 of the orthodontic appliance 202, in accordance with some embodiments. Each polygonal structure 2400 or 2500 has a height h smaller than a planar dimension 1. The polygonal structure 2400 is a hexagram cross section and each of six pointed tips is cut off and flattened, and the polygonal structure 2500 is a four-pointed star cross section and each of four pointed tips is cut off and flattened. Each polygonal structure 2400 or 2500 is attached to a surface of one of the plurality of teeth 208 and has a plurality of receiving surfaces 2402 or 2502 substantially perpendicular to the surface of the one of the plurality of teeth 208. The orthodontic appliance 202 further includes one or more attachment structures 402 each of which is configured to grab, and apply a pull or push force on, a respective one of the plurality of receiving surfaces 2402 or 2502 of the polygonal structure.

Referring to FIG. 26, each receiving surface (also called side surface) 2502 of the polygonal structure 2500 is configured to receive a respective pull or push force that is applied by a force component of an orthodontic appliance 202. The force component optionally includes an attachment structure 402 formed on a reinforcement portion 204 or a shell portion 206. In some situations, the respective pull or push force is substantially perpendicular to the respective receiving surface 2502 where the respective pull or push force is applied. In the force patterns 2600-2650, two or three push forces are applied on separate receiving surfaces 2502 of the polygonal structure 2500 mounted on a corresponding tooth 208 to cause rotation (in force patterns 2600 and 2610), a lateral push (in a force pattern 2620), a mixed push-extraction force (in a force pattern 2630), an extraction force an extraction force from a root (in a force pattern 2640), and a compression force towards the root (in a force pattern 2650).

FIG. 27 illustrates another example force pattern 2700 of the attachment structures 402 of the orthodontic appliance 202, in accordance with some embodiments. Three push forces are applied on three distinct receiving surfaces 2502 of the polygonal structure 2500 mounted on a corresponding tooth 208 to generate a rotational force. The rotational force counteracting an undesirable forward movement. Specifically, a polygonal structure 2500 is attached to a surface of one of a plurality of teeth 208 and has a plurality of receiving surfaces 2502 substantially perpendicular to the surface 208S of the one of the plurality of teeth 208, the orthodontic appliance 202 further includes one or more attachment structures each of which is configured to grab, and apply a pull or push force on, a respective one of the plurality of receiving surfaces 2502 of the polygonal structure 2500.

This force pattern 2700 corresponds to a physiological anchorage. Anchorage is defined as resistant to unplanned tooth movement. Anchorage and anchorage planning are based on Newton's Third Law, i.e., action and reaction being equal and opposite. In some embodiments, a group of teeth are used to move a single tooth. In some embodiments, various classifications/types of anchorage include, but are not limited to extra-oral, intra-oral, Group A, Group B, and Group C. An absolute anchorage optionally applies a temporary anchorage device (TAD), which is basically a mini-implant to act as anchorage. In some situations, a planned anchorage is not enough to resist and counter Newton's Third Law exerted by the target tooth/teeth an orthodontist wants to move. In some situations, the planned anchorage moves cannot be achieved. Anchorage enhancing strategies include, but are not limited to, vector re-direction (e.g., in FIG. 34), distributed anchorage, passive anchorage, and active physiological anchorage (e.g., force pattern 2700 in FIG. 27).

Anchorage is the resistance to unwanted movement of a tooth 208. Anchorage on molar teeth is important when the molars are used as an anchor to retract an anterior teeth. In response to the forward pulling force (e.g., a reactive force from anterior retraction), the molar teeth will tip forward. Commonly, horizontal attachments parallel to the gingiva is used to prevent such forward tipping. However, the horizontal bar is not always effective. To increase the resistance against forward tipping force, current invention puts negative craving on the attachment surface, thus creates a rotational force on the molars in the opposite direction. That reverse rotational force provide extra anchorage to counter a forward tipping force.

FIG. 28 is a cross sectional view 2800 of a tooth 208 that is substantially parallel with a chewing surface of the tooth 208, in accordance with some embodiments. A passive dimple structure 2802 is mounted on a side of the tooth 208. A push force 2804 is generated on the dimple structure 2802 while a corresponding orthodontic appliance 202 is applied on the teeth 208. The push force 2804 causes the tooth 208 to rotate (2806) with respect to a tooth central axis 808, which extends from a root to a crown of the tooth 208.

When a force acts on the tooth that produces a rotation with a shift of center and axis of rotation in 3D space, the system is said to not balanced. If a force is acting perpendicular to the axis of rotation through the center of rotation, that force produces no rotation. Any deviation from the above produces rotation of tooth with its center and axis of rotation shift in 3D space. Self-balanced means a system that controls the shift of the center and axis of rotation in a desirable direction. Self-balanced system can produce pure rotation even when the force acts tangentially to the axis of rotation. Self-balanced system contains minimum of one active force component and minimum one passive component. Active component can be positive or negative with or without shape deformation Passive component takes, but not limited to common geometrical form (round, rectangular, triangular, etc.). Passive component exert force reactively. Passive component is not adhered to the tooth. Passive component allows the tooth surface to glide and slide. Passive component can be imagined as components that confine the movement of the tooth to a well defined space. Self-balanced system is used to produce desirable rotation in 3D space by selectively place the active component and passive component.

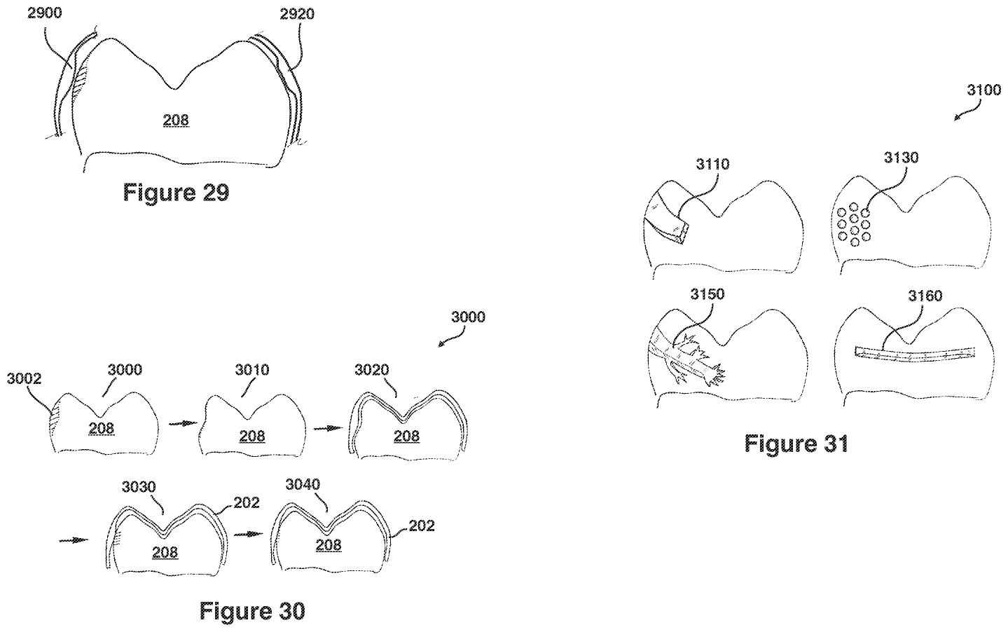

FIG. 29 illustrates two force components 2900 and 2920 having two distinct contact forms with a tooth surface (also called tooth mesh), in accordance with come embodiments. The force components 2900 and 2920 have distinct shapes corresponding to the two distinct contact forms (e.g., a positive contact form, a negative contact form) in relationship to the tooth mesh. In accordance with the positive contact form, a corresponding surface of a tooth 208 has a convex shape and the force component 2900 stays external to the tooth 208. In accordance with the negative contact form, a corresponding surface of a tooth 208 has a concave shape (e.g., is dented), and the force component 2920 crafts away part of the tooth surface, exerting force to the tooth 208 in particular spot/area even if there is no geometric differences between the orthodontic appliance 202 and the tooth 208 of the patient in terms of overall alignment (e.g., on a macroscopic level), i.e., even when the orthodontic appliance 202 is supposedly to be passive. In some embodiments, the concave shape of the corresponding surface of a tooth 208 substantially matches that of the force component 2920. Further, in some embodiments, the force component 2920 is formed by scraping away a layer or creating a groove manually on a stone model before vacuum forming of the orthodontic appliance 202.

FIG. 30 is a flow diagrams of a process 3000 for negative shape modification in digital carving, in accordance with some embodiments. Digital carving is a way of precision negative modification. Digital carving virtually carves (3010) away a designed area on a tooth surface in a tooth model of a tooth 208 in a orthodontic application. A size, shape, depth, and location of carved part 3002 of the tooth model is determined (3200) by computer simulation. An aligner (i.e., an orthodontic appliance 202) is manufactured (3030) according to the modified tooth model of the tooth 208. Since the tooth 208 itself does not experience any physical modification, the resulting orthodontic appliance 202 will not fit the tooth 208, i.e., overfit the tooth 208. The overfitted orthodontic appliance 202 applies (3040) extra force on a portion of the tooth corresponding to the carved part 3002 of the tooth model. The orthodontic aligner 202 continuously applies (3050) the force even when the tooth 208 is moved to a target tooth arrangement, thus producing over-exertion. Stated another way, if not counteracted (either incidentally or by design), the force resulting from the carved part 3002 of the tooth model produces over-correction of the tooth 208.

In some embodiments, digital carving is applied to add a customized extra volume of aligner material with varying parameters selected or determined to deliver exact force vectors at a selected location. The carved part 3002 of the tooth model has a digital carving volume and includes at least four parameters: shape, size, depth, and location in relationship to the tooth 208. In some embodiments, the carved part 3002 of the tooth model does not have a regular geometrical shape, and includes an uneven thickness. The shape of the carved part 3002 of the tooth model is force-driven and outputted via computer simulation. The shape of the carved part 3002 of the tooth model is digital and bio-mechanically-based, and is fully customized with varying structures adopted to deliver accurate force vectors at steps 3200 and 3030. The shape, size, depth, and location are controlled digitally by computer simulation and generative algorithm. The negative shape can be one or a combination of various geometrical shapes, fluidic and with or without virtual deformation of part or whole tooth shape. The negative shape can be effected in conjunction of one or multiple shapes either positive or negative to form a force couples or to eliminate unwanted force vector. The shape parameters changes according to the force vector required for each step and thus optimized to that particular step. The shape will change and optimized for the next step and all the subsequent steps.

FIG. 31 illustrate four example force components 3100 produced by negative carving, in accordance with some embodiments. Negative Craving can be applied to either tooth surface or positive shape, in other words, on attachment. Application of negative shape modification can be used to actively apply force(s) on the positive shape to exert to move the tooth and/or compensate for the underfitting of aligner due to manufacturing deficiency (especially for the thermoforming technique). One clinical examples of negative craving applications are on anchorage, in particular on active anchorage (physiological anchorage). For example, virtual carving is applied on a rectangular force component 3110, an array of dimple force components 3130, a tree-like force component 3150, a beading structure 3160 (in FIG. 41), a spherical force component or the like. Each of the force components 3110, 3130, and 3150 optionally has a variable thickness.

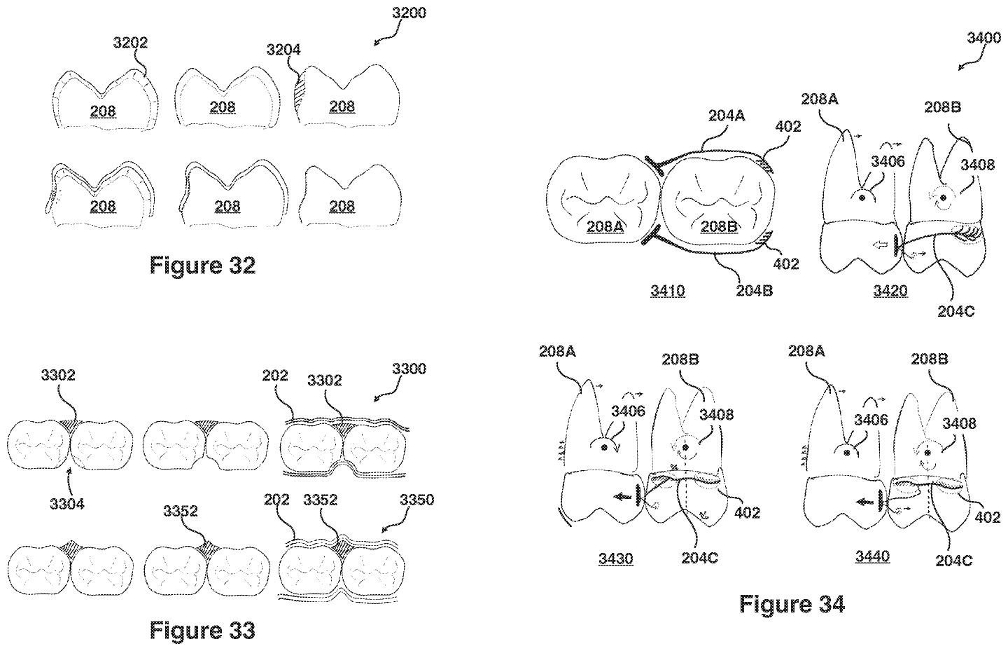

FIG. 32 illustrates overfitting 3200 of an orthodontic appliance 202 with a tooth 208, in accordance with some embodiments. An overfitted orthodontic appliance 202 is loose such that it is not in contact with the tooth 208. “Overfitting in shell” and “shell-offset” are used interchangeably. Overfitting is achieved by virtual expansion or enlargement 3202 of a target tooth arrangement of the orthodontic appliance 202 in an orthodontic application. The resulting orthodontic appliance 202 is then rendered oversized and overfit. In some embodiments, digital carving is applied with virtual expansion or enlargement jointly on a tooth model. A carved portion of the tooth model 3204 is at least partially filled with the orthodontic appliance 202 although the orthodontic appliance 202 is oversized or overfit compared with the tooth 208.

FIG. 33 illustrates two example processes 3300 and 3350 of virtual shape modification, in accordance with some embodiments. A thermoform aligner thickness of an orthodontic appliance 202 is controlled by the process 3300 or 3350. In some embodiments, a shape of the orthodontic appliance 202 is produced by shape modification. Specifically, in an orthodontic application used to determine the orthodontic appliance 202, a virtual material 3320 or 3352 is added to a model result of a patient's teeth. In some embodiments, part of the teeth 3304 is virtually reduced in the orthodontic application. The model result of the patient's teeth are modified to reflect the virtual material 3320 or 3352 or the reduced part of the teeth 3304. As an orthodontic appliance 202 is thermoformed based on the modified model result. The orthodontic appliance 202 conformally hugs the teeth 208 based on the modified model result, leaving space for the virtual material 3320 or 3352 and protruding at the reduced part of the teeth 3304. The virtual material 3320 or 3352 and/or the reduced part of the teeth 3304 are used to modify a thickness and/or properties of the thermoforming orthodontic appliance 202. In some embodiments, self-actuated force components and mechanisms are created by such shape and group shift modifications.

FIG. 34 illustrates vector re-direction 3400 applied to enable tooth anchorage, in accordance with some embodiments. Anchorage is defined as resistant to unplanned tooth movement. One or more teeth form a group to move a single tooth. On a cross section 3410 that is substantially parallel to a chewing surface of a tooth 208, An orthodontic appliance 202 includes two extended and separate reinforcement portions 204A and 204B. Each reinforcement portion 204A or 204B has a first end, a second end opposite to the first end, and an arm connecting the first end to the second end. The first end of the respective reinforcement portion 204A or 204B is landed to on a first tooth 208A. The second end of the respective reinforcement portion 204A or 204B has an attachment structure 402 configured to grab a second tooth 208B immediately adjacent to the first tooth 208A. The arm extended across a body of the second tooth 208B, enabling the second end to grab a surface of the second tooth 208B. In an example, the reinforcement portion 204A is located between the teeth 208 and the lip skin, and reinforcement portion 204B is located behind the teeth 208 and within an interior space of a mouth. In some embodiments, the arms of the reinforcement portions 204A and 204B are further compressed by a shell portion 206 of the orthodontic appliance 202, and cause the first tooth 208A and second tooth 208B to move with opposite directions 3406 and 3408, respectively.

On a front or rear view 3420, 3430, and 3440, a reinforcement portion 204C has a first end, one or more second ends, and one or more arms connecting the first end to the one or more second ends. The one or more second ends and arms are designed according to force to be applied on the second tooth 208B. The first end of the respective reinforcement portion 204C is landed to on the first tooth 208A. Each second end of the reinforcement portion 204C has an attachment structure 402 configured to grab the second tooth 208B. The arms are arranged to extend across a body of the second tooth 208B to connect to the one or more second ends of the reinforcement portion 204C, enabling each second end to grab the surface of the second tooth 208B. In some embodiments, the arm(s) of the reinforcement portions 204C are further compressed by a shell portion 206 of the orthodontic appliance 202. As such, the first tooth 208A is pushed to tip away from the second tooth 208B, and the second tooth 208B is controlled to tip away from the first tooth 208A.

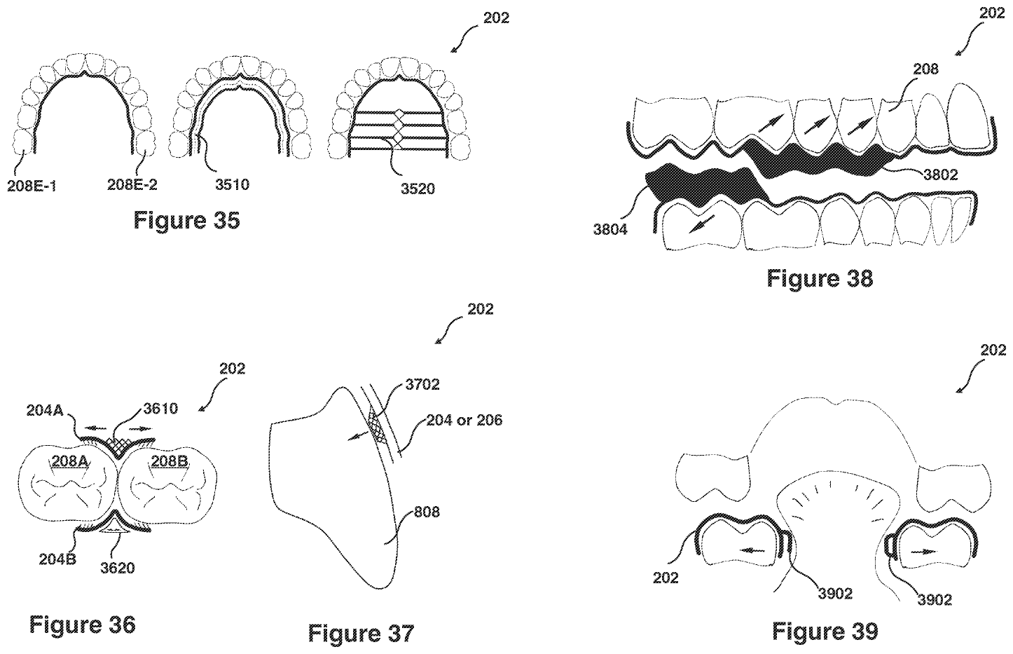

FIG. 35 illustrates an orthodontic appliance 202 applied for arch expansion, in accordance with some embodiments. The plurality of teeth 208 includes a number of successive teeth located between two opposite end teeth 208E1 and 208E2. The orthodontic appliance 202 includes two end portions configured to contact (e.g., hug) the two opposite end teeth, respectively. An actuator 3510 or 3520 is coupled to the two end portions and configured to apply a stimulus to control relative positions of the two end portions of the orthodontic appliance 202. For example, the actuator 3510 includes one or more self-actuation layers configured to generate the stimulus (e.g., heat, vibration, force) for controlling the relative positions of the two end portions. In another example, the actuator 3520 includes a self-actuation structure forming a bridge between the two end portions of the orthodontic appliance 202. The self-actuation structure is configured to generate the stimulus (e.g., heat, vibration, force).

FIG. 36 illustrates an orthodontic appliance 202 coupled with one or more actuators, in accordance with some embodiments. In some embodiments, the orthodontic appliance 202 includes at least one of two reinforcement portions 204A and 204B disposed on two edging areas of two immediately adjacent teeth 208A and 208B. Further, in some embodiments, one or both of two reinforcement portions 204A and 204B include attachment structures 402 configured to contact the edging areas of the teeth 208A and 208B. Alternatively, in some embodiments, the orthodontic appliance 202 includes at least one of two shell portions 206A and 206B disposed on the two edging areas of the teeth 208A and 208B. Further, in some embodiments, one or both of the shell portions 206A and 206B include attachment structures 402 configured to contact the edging areas of the teeth 208A and 208B. An actuator 3610 or 3620 is coupled to an external surface of a corresponding reinforcement or shell portion, and is configured to create a stimulus (e.g., heat, vibration, force) applied onto the teeth 208A and 208B. In some situations, the reinforcement or shell portion is configured to open a space between the teeth 208A and 208B, and the stimulus facilitates opening of the space.

FIG. 37 illustrates another orthodontic appliance 202 coupled with an actuator 3702, in accordance with some embodiments. The actuator 3702 is attached or integrated on an internal surface of a reinforcement portion 204 or shell portion 206 of the orthodontic appliance 202. When the teeth 208 wear the orthodontic appliance 202, the actuator 3702 comes into contact with a crown of a tooth 208 and generates a stimulus applied onto the crown of the tooth 208. The stimulus generates a torque applied on the tooth 208.

FIG. 38 illustrates a set of orthodontic appliances 202 having twin blocks 3802 and 3804, in accordance with some embodiments. The twin blocks 3802 match with each other in a first direction, and configured to block relative movement of the two rows of teeth 208 wearing the set of orthodontic appliances 202 on the first direction. The first direction is optionally aligned with, or perpendicular to, a tooth direction along which the teeth 208 are aligned. For example, the first direction is along a forward direction, and the bottom row of teeth 208 are blocked from moving forward.

FIG. 39 illustrates a set of orthodontic appliances 202 having a tongue blocking structure 3902, in accordance with some embodiments. Each end portion of a bottom orthodontic appliance 202 includes the tongue block structure 3902. The tongue block structure 3902 reduces space left for a tongue, thereby forcing the tongue to take certain positions that optionally create additional forces on the orthodontic appliances 202 and facilitate tooth repositioning.

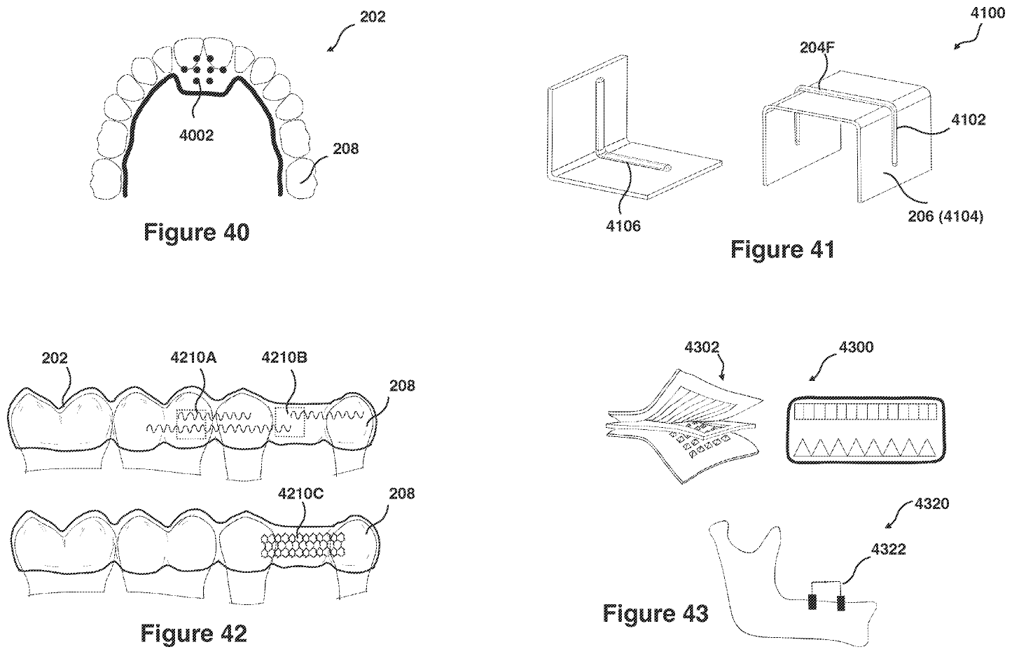

FIG. 40 illustrates an orthodontic appliance 202 having a tongue stimulator or positioner 4002, in accordance with some embodiments. An orthodontic appliance 202 is configured to be worn by a plurality of tooth 208. The tongue stimulator or positioner 4002 is optionally integrated in, or removably attached to, the orthodontic appliance 202. In some embodiments, the tongue stimulator or positioner 4002 creates a bump on the orthodontic appliance 202 and in an interior space of a mouth, allowing a tongue to touch the bump and get stimulated. In some embodiments, the tongue stimulator or positioner 4002 extends from an edge of the orthodontic appliance 202, and located near a top ceiling of the interior space of the mouth or under the tongue.

FIG. 41 is an example reinforcement structure 4102 (also called a beading structure) created on a sheet material 4104 and applied as an reinforcement portion 204, in accordance with some embodiments. In some embodiments, the beading structure 204F of the reinforcement portion 204 is produced via morphological arrangement of the shell portion 206. In an example, the reinforcement portion 204 is formed by beading 4102 in sheet material, i.e., the sheet material 4104 of the same thickness is folded to produce a reinforcement structure of the reinforcement portion 204, which has a curvature. Another beading structure 4106 is defined as a range of discontinuity of a shell or reinforcement structure.

FIG. 42 illustrates two rows of teeth 208 that are coupled to one or more sensors 4210, in accordance with some embodiments. Each row of teeth 208 wears an orthodontic appliance 202 including one or more sensors 4210. In some embodiments, each sensor 4210 is attached to an interface surface or an external surface of the orthodontic appliance 202 and configured to monitor a characteristic of the teeth 208. Alternatively, in some embodiments, each sensor 4210 is integrated on an interface surface, on an external surface, or in a body of the orthodontic appliance 202. In some situations, a sensor 4210 (e.g., 4210B) protrudes into a space between two teeth 208. Each sensor 4210 is one of a chemical sensor 4210A, a photo detector 4210B, and a displacement or pressure sensor 4210C.

FIG. 43 illustrates methods 4300 and 4320 for providing power to sensors and actuators applied with an orthodontic appliance 202, in accordance with some embodiments. In some embodiments, the orthodontic appliance 202 is coupled to a waterproof and stretchable turboelectric nanogenerator 4320 configured for biomechanics energy harvesting and self-powered sensing. Alternatively, in some embodiments, the orthodontic appliance 202 includes a biocatalytic fuel cell 4322. For example, chemicals in a patient's saliva (e.g., glucose, water) or air (e.g., oxygen gas) is utilized to generate power that drives actuators to accelerate orthodontic tooth movement.

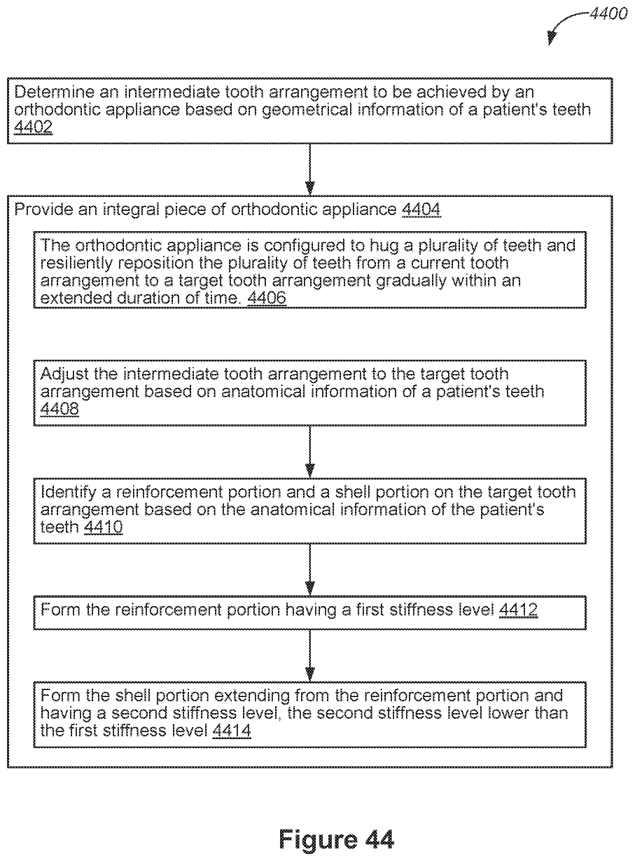

FIG. 44 is a flow diagram of a method 4400 of forming an orthodontic appliance 202 for repositioning teeth 208, in accordance with some embodiments. The method 4440 is executed partially by a computer system. The computer system is configured to execute an orthodontic application for designing the orthodontic appliance 202. The computer system determines (4402) an intermediate tooth arrangement to be achieved by an orthodontic appliance based on geometrical information of a patient's teeth. An integral piece of orthodontic appliance 202 is provided (4404) and configured to hug (4406) a plurality of teeth 208 and resiliently reposition the plurality of teeth 208 from a current tooth arrangement to a target tooth arrangement gradually within an extended duration of time. The computer system adjusts (4408) the intermediate tooth arrangement to the target tooth arrangement based on anatomical information of a patient's teeth 208 and identifies a reinforcement portion 204 and a shell portion 206 on the target tooth arrangement based on the anatomical information of the patient's teeth. Based on the target tooth arrangement, the reinforcement portion 204 and the shell portion 206 are formed (4412 and 4414). The reinforcement portion 204 has a first stiffness level. The shell portion 206 extends from the reinforcement portion 204 and has a second stiffness level. The second stiffness level lower than the first stiffness level.

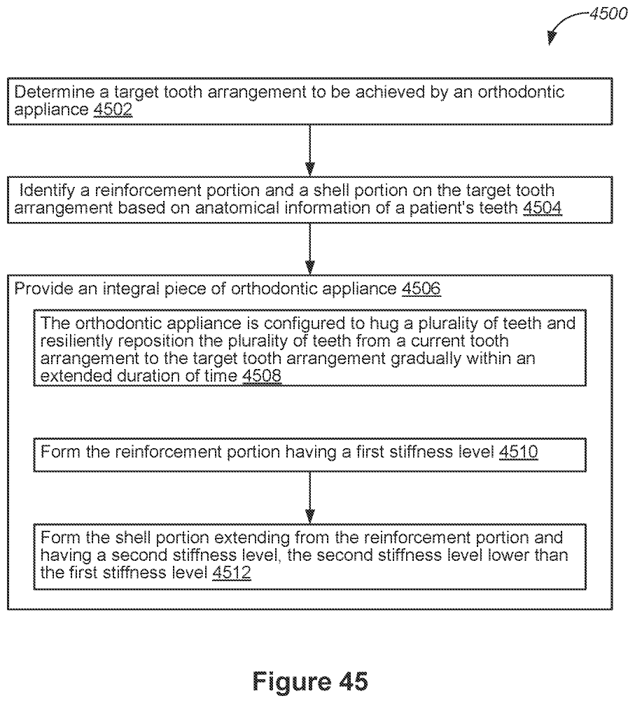

FIG. 45 is a flow diagram of another method 4500 of forming an orthodontic appliance 202 for repositioning teeth 208, in accordance with some embodiments. A computer system determines (4502) a target tooth arrangement to be achieved by the orthodontic appliance 202 and identifies (4504) a reinforcement portion 204 and a shell portion 206 on the target tooth arrangement based on anatomical information of a patient's teeth 208. An integral piece of orthodontic appliance 202 is provided (4506) to hug (4508) a plurality of teeth 208 and resiliently reposition the plurality of teeth 208 from a current tooth arrangement to the target tooth arrangement gradually within an extended duration of time. Specifically, based on the target tooth arrangement, the reinforcement portion 204 and the shell portion 206 are formed (4510 and 4512). The reinforcement portion 204 has a first stiffness level. The shell portion 206 extends from the reinforcement portion 204 and has a second stiffness level. The second stiffness level lower than the first stiffness level.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., according to a communication protocol). In this manner, computer-readable media generally may correspond to (1) tangible computer-readable storage media which is non-transitory or (2) a communication medium, such as a signal or carrier wave. Data storage media may be any available media that can be accessed by one or more computers or one or more processors to retrieve instructions, code and/or data structures for implementation of the embodiments described in the present application. A computer program product may include a computer-readable medium.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, elements, and/or components, but do not preclude the presence or addition of one or more other features, clements, components, and/or groups thereof.

It will also be understood that, although the terms first and second may be used herein to describe various elements, these elements should not be limited by these terms. These terms are only used to distinguish one element from another. For example, a first electrode could be termed a second electrode, and, similarly, a second electrode could be termed a first electrode, without departing from the scope of the embodiments. The first electrode and the second electrode are both electrodes, but they are not the same electrode.

The description of the present application has been presented for purposes of illustration and description, and is not intended to be exhaustive or limited to the invention in the form disclosed. Many modifications, variations, and alternative embodiments will be apparent to those of ordinary skill in the art having the benefit of the teachings presented in the foregoing descriptions and the associated drawings. The embodiments are described in order to best explain the principles of the invention, the practical application, and to enable others skilled in the art to understand the invention for various embodiments and to best utilize the underlying principles and various embodiments with various modifications as are suited to the particular use contemplated. Therefore, the scope of the claims is not to be limited to the specific examples of the embodiments disclosed. Modifications and other embodiments are intended to be included within the scope of the appended claims.

Additional information is incorporated from U.S. Provisional Patent Application No. 63/218,232, titled “Smart Orthodontic Appliances with Hierarchical Structures and Materials,” filed Jul. 2, 2021, as follows:

### Introduction: Biological-Oriented & Entropy Reduction

### Traditional Arrangement-Based and its Limitation

Traditional aligner is geometrical-arrangement-change-driven. The technician moves the teeth to new desirable position macroscopically with a discrete and stepwise distance and rotation (say, like one common prescription—0.2 mm and 1 degree per step). The target arrangement of the teeth (post-treatment arrangement) is achieved via a series of such incremental steps. The aligners are fabricated according to those stepwise teeth arrangement changes. When an aligner is applied to the teeth, the differences between the aligner (desirable teeth arrangement of the next step) and the existing teeth arrangement (current step) creates a discrepancy in 3D space. Such discrepancy (un-fitted-ness) creates an internal strain inside the aligner. While the aligner material resumes its original balance no-strain state, the force so released acts on the teeth via the contact surfaces between the aligner and the teeth. The force moves the teeth into new position. However: the force that is generated via this un-fitted-ness is grossly imprecise and random. Imprecise: Since the force is secondary to the distance, and the force generated by the aligner is in relation to the strain create by the aligner distortion, the amount of distortion and hence the force created can be over (too strong) or under (not enough). Any “Just-correct” force is certainly by luck and definitely not the result of careful design and calculation. Random: Randomness is due to the fact that the technician only plans the macroscopic tooth movement but not the precise point of contact between the aligner and the teeth. The contact points between the tooth and their angle-of-attack is therefore random and changing during the whole course of movement of the tooth. Aligner material that acts on one tooth is interconnected with the material that acts on anther tooth, therefore subject to Newton's third law. This interconnection interplay further complicates the force(s) that act on the teeth. Thus: Initial forces that act on the teeth are randomly directed, complex and counteractive to each other to start with in the early phase of tooth movement; The target tooth is being pushed around by various forces exerting via the random contacts and the resultant reactive force by the adjacent teeth via Newton's third law. Such movement of tooth can be imagined as the tooth is “Vibrating” or wobbling randomly on its way towards its new position. Likewise, the reactive force of the target tooth is exerting undesirable/interfering force on the adjacent teeth (Newton's third law). The randomness (entropy) of the system gradually decrease and comes to stability after all the teeth are forced into the designated morphological arrangement of the aligner of that particular treatment step. The whole process starts again with the insertion of a new aligner for another new step. Conclusion: Current aligner is inefficient and not biologically sound.

### Biological-Based and Entropy Reduction

Biological driven: New aligner is designed and based on: Precise Vector V, that acts on the crown to move a tooth from it pre-treatment orientation and position to its target orientation and position. The path and speed of a tooth moving from pre-treatment orientation and position to target orientation and position is optimized based on the following principal and sequence: Physiological limit—bone remodeling speed. Physiological speed limit is a scientific finding and quantified via evident-based research (out of this patent). Optimal force from scientific research that known as the optimal force to move the tooth inside the bone in optimal speed. The optimal force is use by this system as the primary input (f). Where f is the vector that acts on the tooth root surface at any particular time point in parallel to the direction of the tooth movement. At any time point during the treatment course, any ft value on any randomly sampled root surface shall not exceed f. f is therefore the limiting factor of the system. At any time point during the treatment course, any ft value on any randomly sampled root surface shall be optimized to approach f. Note 1: f can be affected by: the host bone physiology and the cell activities. Presence or absence of biomodulation of any form. Other Biological limitation that may not be conclusively quantified as of now such as the force level that leads to impact on the surrounding structures (buccal alveolar bone); root tip resorption etc. Note 2: f is a parameter that can be updated as frequent as new scientific understanding of bone physiology and evident-based quantification is available. f is adjusted according to the presence or absence of any bio-modulation where the bio-modulation parameter is scientifically and conclusively quantified. Now, the optimization is performed according to the following priority sequence: That at any time and orientation of the tooth, the advancing surface of the root (surface normal to the movement direction) is receiving a vector as close as possible to f (ft→f). Aggregation of all the f on the root surface, which acts on the crown is defined as V. vector V (exert via the crown) is the required vector to move the tooth to from it pre-treatment O&P to its target o&p (under the constrain of f) without causing the tooth to wobble around and along; ie V is pure and without noise. The path between the pre-treatment and target teeth orientation and arrangement shall be the shortest in 3D space. The movement of the teeth towards the destination shall be translated and rotated at the same time as much as possible (analogy: parallel processing). The vector V is translated to force that is required to be applied on the tooth surface to produce desirable V. The optimal application point of V on the tooth surface at any particular time moment is then determined. Force components, as defined in this invention: Any physical structure or structures or any combination of structures, be it attached to the tooth or attached to, or as a part of an aligner that produce a force that affect the position of a tooth and/or number of teeth. The topology of the force components of the aligner or any alteration of tooth-shape which can produce the desirable V is then generated accordingly. Note: that the optimal application point on the tooth surface can be constantly changing as the tooth changes from undesirable crooked location and orientation toward desirable location and orientation. The V that required to optimally maintain a optimal f at anytime point is affected by: Biomechanical parameter: root surface area, root surface morphology, root spatial arrangement; Rule of physics: center of rotation, center of resistance, pivots. The topology of the aligner force components is affected by: The V Aligner material's physical properties. The morphological relationship of the target teeth to its neighbors (Newton's Third Law), which translates to the interplay of aligner materials. Entropy Reduction. The topology of the force component design aims to: Generate optimal vectors that acts on the optimal center of rotation and center of resistance. Randomness reduction (entropy reduction) by carefully align the force components and thus the vector on its optimal location. Properly countered and or balanced all the force components, taking full consideration to eliminate undesirable stray forces(vectors) and the interference due to Newton's third law. The amount of tooth movement is the result of careful force planning, NOT the reverse (ie, not to design the destination position of the tooth then force the tooth to that location with brute force without concerning HOW to better move the tooth). The current method can also be seen as Process-Driven rather than Outcome-Driven.

### Biological-Based Aligner Flow

FIG. 1

### Tooth Movement Efficiency (TME) & TME Index

As per described above, traditional aligner is not efficient in moving the tooth. To quantify the efficiency, current invention introduces a new concept—Tooth Movement Efficiency. A new approach and thus a new tool - Aligner Efficiency Optimizer (AEO) is developed to increase the tooth movement efficiency. Tooth Movement Efficiency (TME) and it's outputted result—Tooth Movement Efficiency Index (TMEI) is allows efficiency quantification of any aligner design. TMEI serves as a fundamental benchmark for various aligner designs comparison. Computer aid designed aligner, be it manual, automated or AI optimization can be compared, benchmark and improved.

### Goal-Orientated Arrangement of Structures and Materials

New generation aligner aims to increase the TME, therefore: Reduce treatment time, Reduce potential of side effects, Lower the cost while provide a faster and better treatment outcome. New aligner achieves improved TME via the combination of the followings: Redefines, re-designs aligner structures and components Constructs the new aligner using mono or multiple materials. Newly defined and designed structures and components are arranged according to their functional goal (see next section). New type of force components are developed for better fluidic control (4D approach rather than Outcome-driven approach). Fully leverage the power of computer algorithm to optimized the arrangement to: Calculate the force required to move the teeth (bone model etc . . . ). Calculate the structures/materials that best produce the force. Leverage other add-on structures that extend the function of aligner and or speed up the tooth moment at the same time. Goal-orientated arrangement general description: Structures and components are largely defined by its function. *Functional structures and components are treated as interchangeable term hereafter; Functional structures can be classified into: Primary and Secondary; Active and Passive. Primary structures: Primary structures are structures that interact(in contact) with the tooth surfaces, Primary structures could be Active (producing force) and Passive (Reactive to the force). Secondary structures: Secondary structures are structures that does not get in contact with the tooth. Secondary structures can also produce force but the force is exerted via the primary structure. Active structures: Active structures are structures that are designed to product force when in contact with the tooth surface actively moving the tooth along the desired path. Active structure become passive when and only when the targeted tooth has reached its designated position. Passive structures are structures that are reactive throughout the tooth movement, ie, do not produce force by design, and only produce reactive force when vectors from other components act on it (eg: smart dimple, see later slide). Combination of Active and Passive structures could create self-balanced or self-countered Couple Structure that produce a pure vector(s) without stray/interfering vectors. Morphological description of structures and components. Structures and components in current invention do not necessary conform to a specific shape. Whatever shape the structure or component it takes is secondary to and only as a function of the force that is required to move the tooth to its target position. Forces required are calculated via computer simulation model which is the theoretical limit of the biologically/physiologically feasible speed limit. The structures are in turn generated by computer simulation model specific to that material or combination of materials. The structures and their arrangement take the shape and arrangement that produce the best and purist vector that moves the tooth in the best (mostly but not always the shortest) path towards its designated position. Materials: The resultant structures range from mono-material to multi-materials. The resultant structures range from discrete or continuous. FIG. 2 or 15.

### Ways of Goal-Orientated Arrangement of Structures and Materials

### Hierarchical Arrangement

Overview: Hierarchical Arrangement of Structures and Material: Mega. Head & neck, extra-oral region; extra-oral devices, structure that extended beyond the oral cavity. Macro: Intra-oral region - intra-arch, maxillary arch or mandibular arch including segment of the arch; traditionally: aligner, functional appliances, removable appliances, fixed appliances. Meso: Individual tooth level, may include up to one extra tooth on each side - finger spring can be considered as one of the examples of meso structures. Micro: Structure of micrometer level, similar to setae of Gecko's foot. Nano: Structure of nanometer level, similar to the spatular of the Gecko foot. https://people.cccs.berkeley.edu/˜ronf/Gecko/Hierarchy3.jpg

Mega: maxillofacial level. Myofunctional, TMJ. Growth modification, Inter-arch (occlusal force). Properties: Large structure providing bulk structure for human manipulation. Stiff, non-flexible material. Structural integrity. Long range force transmission. Transmit force effectively (for biomodulation, eg: low-intensity pulsed ultrasound LIPUS). Light transmitting/wavelength modification (for photobiomodulation). Relatively homogenous. Surface modification with variable material and surface treatment to improve patients comfort, drug release etc . . . Macro. Dental arch level (more than one tooth). Relatively stiff forming the basis for the force delivery (mostly isotropic, non-compliant). Flexible enough to engage tooth undercut in macro scale (millimeter to sub-millimeter level). Provide structural integrity enough to withstand repeated insertion and removal from dental arches. Provide handling structure for human manipulation. Discrete - able to form lone-standing structure. Diffused - able to spread thin enough and blend in with the surrounding material to form a continuous material spectrum without clear material-material interface. FIG. 3. Meso. Single tooth level (may span across more than one tooth - eg: inter proximal). Relatively stiff for precision force delivery (anisotropic, directional, non-compliant). Non-compliant to allow micro and nano level adhesion to disengage from the tooth surface. Flexible enough to engage tooth undercut in sub-millimeter level if necessary. Provide structural integrity enough to withstand repeated insertion and removal from dental arches. Discrete—able to form lone-standing structure. Diffused—able to spread thin enough and blend in with the surrounding material to form a continuous material spectrum without clear material-material interface. Smooth transition and fusion with Micro level material and structure. Micro. Small region of tooth surface (Multiple Triangular/tetrahedral mesh level). Soft to provide maximum compliant to tooth surface. Discrete—able to form lone-standing micro structure at micro-level. Diffused—able to spread thin enough and blend in with the surrounding material to form a continuous material spectrum without clear material-material interface. Smooth transition and fusion with Nano level material and structures. FIG. 4. Nano. Nano scale. Soft to provide maximum compliant to tooth surface. Maximum contact area with the target contact surface. Discrete - able to form lone-standing nano structure. Smooth transition and fusion with micro level material and structures. FIG. 5. FIG. 6.

### Biomimetic—New Types of Force Delivery

Adhesive force via nano-structures. Adhesive force via Gecko-like structure. Adhesion along the surface/tangential to curve surface—>Pulling force. Released by vertical force normal to the surface—>peeling off. Adhesive force via Tree-fog-like structure. Adhesion normal to the tooth surface—pull force normal to the attached surface. Release by tangential force. Micro-pillar arrays. Nanopits. Adhesion under wet conditions. FIG. 7.

### Biomimetic—Force Delivery Via Adhesion

| Current invention | All traditional aligner - push only action |
|---|---|
| Pull action applied along the | Complex and inefficient force vectors |
| tooth surface with clean and | The attachment shape and hence resultant |
| effective resultant vector | effective force vector is further |
| No need to modify tooth | compromised by the requirements to allow |
| morphology | the aligner to be inserted and removed |
| No attachment | with ease by the patient |

Also see FIG. 8

### Biomimetic—Skin, Muscle & Skeleton

Skeletal structure to: Provide structural stability. Provide structural flexibility. Deliver precision, controlled force/vector. Skin-Shell: Provides coverage and protection to underlying structures. Link all structures and materials together for easy human management (patient to take out and insert the aligner). Shell can be designed to be opened or partial open to: Reduce coverage of tooth surface—>facilitate salary flow and thus reduce the impact of artificial man-made object from interfering oral self-healing. Reduce coverage of tooth surface in occlusal area—>reduce occlusal interference|increase efficiency in occlusion/articulation. Shell can be designed to be closed as traditional aligner. Details sec section below . . . FIG. 9.

Muscle: Transitional or combinational of material and structure(s). The body of material that store the strain and the subsequent relaxation to produce force that moves the tooth. Self-actuation material can be view as one form of flesh (see section below)

Self-actuation Components Self hydro|thermo|electrical|chemical|mechanical actuation. Hydrophilic materials. Typically outer layer in contact with saliva or micro-film of the surface. Absorb water and expand in volume. Arrange as tube along the line of force—elongation. Arrange at an angle to the line of force—open/close action. Arrange as honeycomb for larger area application. Thermo-sensitive materials. Expand/contract in responds to endogenous body heat. xpand/contract in response to extraneous heat (either induce via electro, acoustic, induction, direct connection or self-powder by harvesting endogenous energy—see below). Embedded at the surface or deep in the structure. Hydro-actuation. Honey-comb structure expand and contract in the presence of water. Hydrophilic materials. Typically outer layer in contact with saliva or micro-film of the tooth surface. Absorb water and expand in volume. Arrange as tube along the line of force—elongation. Arrange at an angle to the line of force—open/close action. Arrange as honeycomb for larger area application. Thermo-sensitive materials. Expand/contract in responds to endogenous body heat. Expand/contract in response to extraneous heat (either induce via electro, acoustic, induction, direct connection or self-powder by harvesting endogenous energy—see below). Embedded at the surface or deep in the structure. Electrical materials. Conducting circuit embedded to harvest the electrical energy. Electrical energy so harvest is used to actuate the mechanical device (expand, contract, elongate, rotate). Chemical. Concentration of certain chemicals, in oral environment=calcium level etc.. Mechanical. The mechanical stretching triggers expansion of half-auxeticity or auxetic materials. Thus creating force. Half-Auxeticity and Anisotropic Transport in Pd Decorated Two-Dimensional Boron Sheets. https://pubs.acs.org/doi/pdf/10.1021/acs.nanolett.0c04154. FIG. 10.

### Functions and Examples of the New Aligner Framework

### Functional Components (Ref 2.3 Biomimetics)

Shell. Outer protective. Partial merge with skeleton. Skeleton. Provide structural stability. Relatively strong via. Different or brands of multi-materials. Varying thickness of mono-material. Provide force or dissipation of force. FIG. 11. Force components. Varying structures specifically to store the strains and deliver force. Range from simple to complex structures. FIG. 2.

### Shell and its New Design

Overall. Traditionally, aligner is one single piece of plastics. Any additional features, dimples, bars etc exert force via the intrinsic strain of the shell, as such, shell is actually a force component. Now, Current invention see shell as a distinct structure that serves as:

Connector. Protective cover. Force component. FIG. 12. Shell-Offset. Basic Concept—To eliminate undesirable force exerted on teeth. Description: Macroscopic aligner shell is designed and fabricated to not contacting or selective contacting the tooth surface. The shell can be imagined/visualized as floating around the teeth. Force components designed to exert forces are then in direct contact with the tooth surfaces at designed areas with specific orientation. Desirable force can then be exert without the interference of forces from the shell; If any force is expected to be coming from the shell, those force will be exerted. via the tooth-contacting force components. Nano structures (created by surface treatment or other means) of the force component will be effective due to their direct contact with the tooth surface while the same nano treatment of the offsetted-shell will be rendered passive due to its lack of contact with the tooth surface. FIG. 13. Open-Shell Design. Open shell—unwanted shell regions were removed. Only the portion of the shell that serves the function mentioned above will remains. Eg: To act as a protection shield to avoid damage to underlying force components. To act as a base-support to provide reactionary force dissipation to other structures. The resulting shell is a shell with multiple perforations of varying sizes in multiple locations. The shell connects to the skeleton and or force components in 2 ways: At the base (leaving free-end structures). All along (structures “protruding” from the shell). The Open-shell can be implemented with or without shell-offset. FIG. 14. Close Design. Resembles the traditional thermoforming aligner with complete coverage of all the teeth. No perforation or punctures. Other features same as Open-Shell design. The Close-shell can be implemented with or without shell-offset. Figure. 15. Stepwise Implementation. All the above design can be implemented in per step basis independent from the other steps. Example: step one=openshell, step two=closeshell. All the above design can be implemented in per arch basis independent from the other arch. Example: Upper Arch=openshell; Lower Arch=closeshell. Conceptual see 4D Optimization. Force components. Morphological Classification: Arm-like:Elongated with one or multiple turns with or with palms and fingers at the end. Tree-like: Tree-like with or without a main trunk, with or without symmetrical or repeating structures. Combination: the end of the Tree-like structure can be arm-like with or without palms and or fingers. Fluidic: a pond-like structure where the earth is the tooth and the water of the pond is the force component. Skeleton-like: Interlinked structure forming a skeleton, or alien skeleton when arranged without symmetry. Pattens & Array: array of geometrical shape; eg: array of round dots and dimples. Geometrical: most traditional round/oval; square/retangular/trapezoid; paired-geometrical (2 half-oval); all with or without any offset cut. Macroscopic: shell. Self-actuation. components: honeycomb, strip, balloon, Design examples. Tip. FIG. 16. Torque. FIG. 17. Rotation. Provisional. Application FIG. 18. Extrusion. FIG. 19. Bodily Movement. FIG. 20. Space opening. FIG. 21. Closing. FIG. 22. Anchorage. FIG. 23. Classification in reference to the tooth mesh. Force components of various shape can be designed and manufactured by positive or negative in relationship to the tooth mesh (tooth surface): Positive: the force components are designed to stay “outside-of-the-tooth” in reference to the tooth surface. Negative: the force components are designed by “crafting away” part of the tooth surface virtually, hence exerting force to the tooth in particular spot/area even if there is no geometric differences between the aligner and the patient in terms of overall alignment (macroscopic level). ie, even when the aligner is supposedly to be Passive. Note: negative method was practiced by scraping away a layer or creating a groove manually on the stone model before vacuum forming of aligner/repositioner in the pre-digital agw. FIG. 29. Shape modification force components. Positive Shape Modification. Positive modification is by adding material to the tooth surface. Traditionally by adding Attachment to the tooth surface using composite material. Attachment effectively change the morphology of the tooth and hence the force it received. Traditional Attachment Design. Traditional attachment mostly has one flat surface that allows aligner force exertion. Traditional attachment, once attached, would remains in place for the most of the treatment steps. The force receiving surface thus changes when the tooth moves. The force that acts on the surface would be rendered sub-optimal. Specific Positive Shape Modification Design—Universal Attachment. Current invention utilized multiple force acting flat surfaces at pre-calculated angles. Multiple flat surfaces design takes into account the changes in tooth position during whole treatment process, yet the system still be able to exert optimal force via another surface and or combination of multiple surfaces. Multiple flat surfaces allows self-balanced and self-countered forces, actively exerts pure vector along the desired direction. Multiple flat surfaces allow pre-calculation, pre-optimization for the whole treatment process (See 4D optimization)

Universal 4D Attachment example; Note: The angle between surfaces can varies as per optimization algorithm's prescription. Further details of multi-surface Universal 4D Attachment: sec 4D optimization. FIGS. 24 and 25. FIG. 26. Negative Shape Modification - Digital Carving. Digital carving is a way of Precision negative modification. Digital carving virtually carves away specifically designed area on the tooth surface. The size, shape depth and location is determined by computer simulation. The aligner is manufactured according to the modified tooth shape. Since the tooth in reality does not experience any physical modification, the resulting aligner thus will not fit the tooth, thus OVERFIT. The overfitted aligner will exert extra force on the digitally carved region of the tooth. The aligner will continuously exerting the force even when the tooth is moved to the designated position, thus producing “over-exertion”. If the resultant force of the carving is not countered (either by accident or by design), it will then produce “over-correction” of the target tooth. Digital carving can be imagined as a customized “extra” volume of aligner material with varying parameter calculated to deliver exact force vectors at that particular step. Digital carving volume consists of 4 Parameters: shape, size, depth and location in relationship to teeth. In practice, since the shape is not a well defined geometrical shape, it is likely to be a fluidic free from of varying thickness. Summary of Current invention vs traditional craving: traditional: geometrical shapes, arbitrary shape, with arbitrary size and arbitrary depth mostly manual and according to operators experience. Current invention: Force-driven and output via computer simulation; fully digital, bio-mechanical-based, fully customized shape of varying structures calculated to deliver exact force vectors at that particular step. The shape, size, depth and location is controlled digitally by computer simulation and generative algorithm. The negative shape can be one or the combination of various geometrical shapes, fluidic and with or without virtual deformation of part or whole tooth shape. The negative shape can be effected in conjunction of one or multiple shapes either positive or negative to form a force couples or to eliminate unwanted force vector. 4D shape: The shape parameters will change according to the force vector required for each step and thus optimized to that particular step; The shape will change and optimized for the next step and all the subsequent steps. Hence overall optimization. FIG. 30. Specific Negative Shape Modification Design. Negative Craving can be applied to either tooth surface or positive shape, in other words, on attachment. Application of negative shape modification can be used to: Actively apply force(s) on the positive shape to exert to move the tooth. Slightly carved to compensate for the underfitting of aligner due to manufacturing deficiency (especially for the thermoforming technique). One clinical example of Negative Craving application is on anchorage, in particular on active anchorage (physiological anchorage). Virtual carving of any force components, rectangular, spherical, tree-like, arrays or any desirable shapes to produce desirable force components. Examples of force components created by negative carving. FIG. 31. Other features created using Shape Modification. Definition of overfit: the aligner is too loose and therefore no in contact with the tooth. Overfitting in shell is shell-offset and is used interchangeably. Overfitting is achieved by virtual expansion or enlargement of the target tooth or shape, the resulting aligner is then rendered oversized and thus overfit. FIG. 32. Thermoforming aligner thickness modification. Thermoform aligner thickness can be controlled by shape modification. FIG. 33. Various aligner shape structure can be produced by shape modification. Adding virtual material to the model results in model that is different from the real patient, the aligner that manufactured from the modified model will conform to the modified model rather than the real dentition. Virtual material, add or removed from the digital dental model can be used to modify the thickness and the properties of the thermoforming aligner. Self-actuated force components and mechanisms can be created by shape and group shift modification.

Special Characteristics of the new framework. Self-Balanced. Definition. In our context, When a force acts on the tooth that produces a rotation with a shift of center and axis of rotation in 3D space, the system is said to not balanced. Future illustration: If a force is acting perpendicular to the axis of rotation through the center of rotation, that force produces no rotation. Any deviation from the above produces rotation of tooth with its center and axis of rotation shift in 3D space. Self-balanced means a system that controls the shift of the center and axis of rotation in a desirable direction. Self-balanced system can produce pure rotation even when the force acts tangentially to the axis of rotation. Description. Self-balanced system contains minimum of one active force component and minimum one passive component. Active component can be positive or negative with or without shape deformation. Passive component takes, but not limited to common geometrical form (round, rectangular, or triangular etc). Passive component exert force reactively. Passive component is not adhered to the tooth. Passive component allows the tooth surface to glide and slide. Passive component can be imagined as components that confine the movement of the tooth to a well defined space. Application. Self-balanced system is used to produce desirable rotation in 3d space by selectively place the active component and passive component. Example: FIG. 328. Self-Countered. Definition. When a force acts on the tooth that produces a translational movement along an unintended direction 3D space, the force is stray and the system is said to not countered. Self-countered means a system that controls the translational movement in a desirable direction. Description. Self-countered system contains minimum of one active force component and minimum one passive component. Active component can be positive or negative with or without shape deformation. Passive component takes, but not limited to common geometrical form (round, rectangular, or triangular etc). Passive component exert force reactively. Passive component is not adhered to the tooth. Passive component allows the tooth surface to glide and slide. Passive component can be imagined as components that confine the movement of the tooth to a well defined space. Application. Self-countered system is used to produce desirable translation in 3d space by selectively place the active component and passive component. Self-countered system is used to resist the undesirable translation in 3D space. Example: Specific Application Example: Anchorage. Concept of anchorage. Anchorage is defined as: Resistant to unplanned tooth movement. Anchorage and anchorage planning is necessary because of Newton's Third Law: Action and Reaction equal and opposite. Common anchorage strategy in orthodontics: Use a group of teeth to move a single tooth. Various classification/types of anchorage: extra-oral, intra-oral, Group A, Group B, Group C, etc . . . Absolute anchorage—use of TAD (Temporary Anchorage Device)—basically mini-Implant to act as anchorage. Not a single anchorage mechanisms is ideal (thus so many different strategies, means and types). Problem of Anchorage loss. The planned anchorage is not enough to resist and counter Newton's Third Law exerted by the target (the one orthodontists wants to move) tooth/teeth. The planned anchorage moves (see definition above)—>clinically=Anchorage Loss—thus—>planned result cannot be achieved. Strategy to enhancing anchorage: FIG. 27. Vector re-direction. Distributed anchorage. Passive anchorage. Active physiological anchorage. Example 1: Active Physiological Anchorage. Anchorage is the resistance to unwanted movement of a tooth. Anchorage on molar teeth is especially important when the molars are used as an anchor to retract the anterior teeth. In response to the forward pulling force (reactive force from anterior retraction), molar will tip forward. Commonly, horizontal attachments parallel to the gingiva is used to prevent such forward tipping. However, the horizontal bar is not always effective. To increase the resistance against forward tipping force, current invention puts negative craving on the attachment surface, thus creates a rotational force on the molars in the opposite direction. That reverse rotational force provide extra anchorage to counters the forward tipping force. Illustration: Example 2: Vector Redirection Anchorage. FIG. 34.

Examples of Self-Actuation in Orthodontics. Arch Expansion with Self-Actuation Structures. FIG. 35. Open Space with Self-Actuation Structures. FIG. 36. Torque with Self-Actuation Structures. FIG. 37.

Other Example of Macro-structure Integration. FIG. 38, FIG. 39, FIG. 40.

### Orthodontics Optimization

Background. As per described above, traditional aligner is not efficient in moving the tooth. New tool should be developed to increase the tooth movement efficiency. Tooth Movement Efficiency (TME) and Tooth Movement Efficiency Index is developed. TME is quantitative measurements that usher the orthodontics into new era of bring evidence-based dentistry into every single patients. TMEI serves as a fundamental quantifiable benchmark for various aligner designs comparison. Computer aid designed aligner, be it manual, automated or AI optimization can be compared, benchmark and improved.

### General Concept of TME

Orthodontics uses force/torque to displace and rotate a tooth. In practice, due to the limitation of orthodontic appliances, the actual force/torque applied onto each tooth can mismatch the required force/torque in direction and magnitude. TME attempts to quantify such a mismatch between −1 and 1: TME equals to 1, when the expected displacement/rotation from the OFEM force/torque vectors completely match the directions of target displacement/rotation and the magnitude of expected displacement/rotation are strictly proportional to that of the target displacement/rotation; TME equals to −1, when the expected directions are completely opposite to the target and the expected magnitude is completely proportional to the target. TME equals to 0, when the expected directions are orthogonal to the target. Average TME of aligner without attachment is around 10-20%. Average TME of aligner with attachment is around 35-45%.

### Calculation of TME

Tooth Movement Efficiency quantifies directional alignment between

displacement/rotation and force/torque as well as the proportionality among the magnitude of force/torque and displacement/rotation of each tooth. TME is composed of two components: Force-displacement (TFD) and Torque-rotation (TTR). Where. TME=TDF+TTR. Force-displacement concerns about the amount of force, its resultant vectors and the moment and displacement that they produce. Where; unintended and undesirable force/vector is a negative value (Stray Force−Fs). Desirable force/vector is a positive value (Resultant Force−Fr). Resultant Force Fr=F−Fs. Magnitude of the displacement produced is in proportion to the resultant pure force/vector

$$D ∝ \frac{Fr}{BoneResistance}$$

Magnitude of displacement is subject to resistance of movement arose from the bone resistance, which is represented by the computer bone model. Torque-rotation concerns about the amount of rotation produced given a torque. Rotation is constituted of the initial force F, its distance and angle from and between the center of rotation and center of resistance. Where: unintended and undesirable TTR is a negative value (Stray Torque−Ts). Desirable torque is a positive value (Resultant Torque−Tr). Resultant Torque Tr=T−Ts. Magnitude of the rotation produced is in proportion to the resultant pure Torque. Optimization. Goal of Optimization. Goal. Shorter treatment time. Less side-effect (tooth resorption, periodontal problem). Lower cost to patient. Eliminate human error. Intra-DOF Optimization. Force/Torque exerted on each tooth can be projected into the direction of target displacement/rotation. Their residual creates undesirable displacement/rotation can needs to be minimized. Description: Implementation flow. Example. Inter-Tooth Optimization. Due to the conservation of total force/torque, TME optimization of a single tooth can not be achieved without affecting other teeth. Coordination is needed to co-optimize the TME of multiple teeth. Description: how. Implementation flow. Example. Optimization Flow. 4D Optimization

Problem of Traditional Approach. Tooth shape modification via attachment is “permanent” and always last for the whole treatment course across multiple steps. The TME of the aligner thus changes according to the orientation of the modified tooth since the force receiving surface of the attachment is under constant change in orientation. The TME of the aligner hence follows a curve with optimal efficiency at certain time steps but never most of the time steps. 4D optimization: 4D optimization aims to optimize the TME across all or most of the time steps. By maintaining the efficiency at all/most time steps, 4D optimization can significantly reduce the treatment time. TMEsystem=TME1+TME2+TME3 . . . TMEn. Description. Current new designs reduce or eliminate attachment. Force components (positive or negative, see later slides) are mostly designed and built into the aligner. Universal attachment provides multiple force receiving faces for continuous optimization throughout all the treatment time steps in case tooth surface adhering positive shape modification is inevitable. The force component (shape, size, depth/thickness, position and counter-components) is designed according to the force vector required according to the orientation of the tooth in its precise 3D space and thus optimized to that particular step; The force components changes and optimizes for the next step and all the subsequent steps. Hence overall optimization. 4D optimization with Universal 4D attachment. Universal attachment with multiple force receiving face and guiding/gliding faces can be continuously maintain its optimization even when the target tooth/teeth position and arrangement has changed.

### Integration of Other Functional Components

### Continuous Chemical Release Via Micro|Nano Pits and Capsules

Nano capsule embedding allows continuous chemical release. Chemical inside nano-capsules can be released in a controlled manner via various activation mechanisms (thermo-activation, hydro, physical). The nano capsules can be evenly distributed or embedded in certain area to produce desirable effect. The nano capsule can be embedded with nano or micro level materials. Nano capsule embedding effective eliminates the need for a macroscopic “pool”. Nano capsule embedding can be applied to open or close shell design. Chemicals that can be embedded includes but not limited to: Chlorhexidine Gulconate (periodontal disease, bacteria killing). Sodium Fluoride (caries). Calcium (tooth repair). Bleaching agents (tooth whitening). Others: antibiotics etc . . . https://pubmed.ncbi.nlm.nih.gov/32295336/ Emerging Nanotechnologies in Dentistry∥Nanodiagnostics in microbiology and dentistry.

### Shell-Offset as Chemical Reservoirs.

Shell-offset design is a natural reservoir for chemical treatment. Shell-offset reservoirs can be applied to close shell. Chemicals are as 5.1 above. Shell-offset reservoirs can be combined with micro|nano pits and or capsules.

### Nano-Sensor.

Nano sensor embedding. Types of nano sensors. ph sensor. Displacement sensor. Pressure sensor. Chemical sensors. https://www.cell.com/matter/pdfExtended/S2590-2385(20)30671-8. Integrated contact lens sensor system based on multifunctional ultrathin MoS2 transistors. Multifunctional lens sensor system could revolutionize smart contacts. https://techxplore.com/news/2021-01-multifunctional-lens-sensor-revolutionize-smart.html. https://www.cell.com/matter/pdfExtended/S2590-2385(20)30671-8. Multifunctional lens sensor system could revolutionize smart contacts. https://techxplore.com/news/2021-01-multifunctional-lens-sensor-revolutionize-smart.html. FIG. 42

### Biomodulation

Photonic. Electrical. Mechanical. Photo. Nanotechnology in orthodontics. 1520 μA of low direct current (dc) was applied to the alveolar bone by modifying the bioelectric potential, osteoblasts and periodontal ligament cells demonstrated increased concentrations of the second messengers cAMP and cGMP. Light-emitting tattoo engineered—https://www.sciencedaily.com/releases/2021/02/210226121319.htm. Ultrathin, Ultra-Conformable, and Free-Standing Tattooable Organic Light-Emitting Diodes—https://onlinelibrary.wiley.com/doi/epdf/10.1002/aelm.202001145.

### Energy Harvesting

For self-powered sensor. Energy harvesting to power nano-sensor. Energy harvesting via Chemical energy. Energy Harvesting via mechanical Nano Generator. FIG. 43.

Align High-level: Aligner that is primarily Biological-driven and based on physiological limit of bone remodeling (not the path-driven or arrangement-driven). Any aligner generation algorithm updatable via updated bone model. Any aligner generation algorithm that is based on or primarily similar to the optimization flow of current invention. Any aligner that is designed and generated via precision force delivery (instead of morphological driven). Any algorithm that claims to measure Tooth Movement Efficiency (TME). Any aligner or algorithm that claims to use TME as an objective quantification. Any algorithm that use TME or TMEI in association with their aligner and aligner product marketing. Any algorithm that employs the TME/TMEI or similar efficiency measuring tool to compare, filter, select and improve the aligner design, generation and output. Any automatic aligner generation based on the above mechanisms.

### Aligner Design:

Any aligner that is based on hierarchical arrangement of structures and materials. Any hierarchical structure of biomimetic nature and in hierarchical arrangement with mega, macro, meso, micro and nano structures. Any aligner that clearly defines and separates the shell, skeleton, force components and add-on components. Any aligner that produce adhesive force on all or some selective areas and/or active components. Any aligner with shell that does not contact the tooth. Any aligner with force components that contacts the tooth. Any aligner with one or more guiding/gliding/sliding structures or components. Any aligner with design that allows the desirable force components to achieve precision surface contact without the interference of other parts of the aligner. Any aligner with one or more opening on the aligner. Any aligner with hydroplaning avoidance and saliva draining mechanisms.

### Force Component Design:

Algorithm that calculates and outputs the size, shape and structures of the force components according to the aligner materials' physical properties. Algorithm that calculates the size, shape, structures according to their separate and combined physical properties in multi-material aligner. Algorithm that places the size, shape and structures in specific location on the tooth surface or surfaces that produces precise vector. Force components with hierarchical structures and materials. Force components that are self-balanced. Any aligner with positive or negative or other force components that is balanced by other positive or negative and/or other force components be it active or passive to keep the center of rotation in desirable 3D space; and/or to shift the center of rotation in a desirable path in according to the design. Force components that are self-countered. Any aligner with positive or negative or other force components that is countered by other positive or negative and/or other force components be it active or passive to keep the path of translation and the shift of the center of pivot and center of resistance in desirable way and in according to the design. Any mechanisms to balance the force—be it by design purposes or to prevent other forces from interfering the precision force delivery. Amy mechanisms to counter the force -be it by design or to prevent other forces from interfering the precision force delivery. Aligner that employs positive and negative attachments. Aligner that employs negative attachments to produce active force even when the aligner overall is passive. Aligner that produces force components with virtual carving. Aligner that produces thickness change using virtual shape modification. Aligner with actuation mechanisms using virtual carving and/or shape modification. Aligner with actuation/force component using group shift and or with visual carving and/or with shape modification. Aligner that produces pull action. Aligner that produces pull and push and/or any combination of actions.

### All-in-One Attachment

Aligner that utilizes any forms of all-in-one attachment. Attachment that is constructed with more than one force receiving surfaces. Attachment that allows forces to act sequentially or simultaneously on one or more force receiving surfaces. Attachment with force receiving surfaces in custom orientation and angulation to each other force receiving surfaces that allows continuous and optimal force exertion, according to and adjusting to the change of orientation of the tooth during the course of treatment. Attachment with surface that allows the sliding of the force components when the tooth moves yet maintains the same vectors. Gripping. Aligner that employs gripping mechanisms. Any aligner that employs inter teeth aligner material as source of force. Any aligner that employs gripping mechanisms on the tooth crown area. (Illustration and description: Similar to the fixed appliances where the grip is the bracket and the inter-teeth aligner material as wire). Self-actuation. Any aligner that incorporate any self-actuation mechanisms of any kind, be it structural or material. Any aligner that incorporate any self-actuation mechanism that will be actuated via hydro, thermo, electrical, chemical, mechanical or any other means. Thermoforming Aligner. Any thermoforming aligner with shell-offset using virtual shape modification. Any thermoforming aligner with force components created via virtual carving and/or with shell-offset. Any thermoforming aligner that employs virtual shape modification to alter the form, thickness and physical properties of the aligner. Any thermoforming aligner that employs virtual shape modification to create self-actuation mechanisms. Any thermoforming aligner that employs group. Any thermoforming technique that creates the above effects.

### 4D Optimization and Multi-Level Optimization

Intra-Tooth. Any algorithm that performs on tooth that optimize the force to align with the desirable direction of movement. Any such optimization that self-adjusted and pre-adjusted to optimized when the tooth orientation changes. Inter-Teeth. Any optimization algorithm and the aligner it generates that takes into the consideration of Inter-teeth interaction and the effect of Newton's Third Law. Any optimization algorithm and the aligner it generates that takes into the consideration of Inter-teeth interaction and the effect of Newton's Third Law and self-optimized when the inter-teeth arrangement changes. Inter-step optimization. Aligner that allows continuous and optimal force exertion, according to and adjusting to the change of orientation of the tooth during the course of treatment. Multi-level. Any aligner that is generated using one or any combination of the above algorithms.

### Nano-Technologies—Contact Surface Design.

Any aligner that employs adhesive technologies to produce adhesive force on the tooth surface. Any adhesive technologies employed to alter the microscopic or nanoscopic surface contact areas between the tooth and the aligner to produce adhesive force to the tooth. Any such adhesive technologies that employs hierarchical structures and materials. Any such adhesive technologies that produce pull actions on the tooth. Any such adhesive technologies that produce pull action normal or tangential to the tooth surface and/or in any angle in between the above. Any such adhesive technologies that produce push action (that rendered the contact relatively stable without slipping along the tooth surface). Any technologies that produce adhesive force on the tooth surface. Any nano technologies that produce adhesive force. Any surface treatments on the aligner that produce adhesive force. Any surface treatments on the aligner that produce self-cleansing surface. Algorithms that support multiple manufacturing technologies. Any algorithm that supports multiple manufacturing technologies, such as but not limited to, single material thermoforming, multiple material thermoforming, single material direct 3D print, multiple material 3D printing. Any algorithm that optimized for specific manufacturing technologies, including but not limited to, single material thermoforming, multiple material thermoforming, single material direct 3D print, multiple material 3D printing.

### Integration of Self-Actuation Components

Any aligner that incorporates any forms of self-actuation mechanisms. Any self-actuation mechanisms that produces 3D movement in 6 dimension including but not limited to expansion, contraction, deflection and curling actions. Any self-actuation mechanisms that can be activated via including but not limited to hydro, thermo, chemical, electrical or mechanical. Integration of other components. Chemical reservoirs. Any aligner that includes micro or nano reservoirs for chemicals. Micro or nano reservoirs includes but not limited to micro/nano pits and micro-nano capsules. Any selective distribution of micro or nano reservoirs localized to parts or whole or multiple teeth. Any selective distribution of density of micro or nano reservoirs. Any shell-offset design that acts a chemical reservoirs. Any combination of the above.

### Energy Harvesting

Any aligner with built-in energy harvesting devices. Any energy harvesting devices including but not limited to thermo-driven, chemical-driven or mechanical driven. Any aligner with built-in energy harvesting device to power nano-sensors and/or for bio-modulation.

Micro and/or Nano-Sensor

Any aligner that embeds nano-sensors. Any aligner that embeds pH sensor, Displacement sensor, Pressure sensor, Chemical sensor or other sensor of any kind. Any micro and/or nano-sensor that is passive or active. Any micro and/or nano-sensor that utilizes built-in energy harvesting devices.

### Bio-Modulation

Any aligner that integrates bio-modulation module. Bio-modulation includes but not limited to mechanical, photonic and electrical.

What is claimed is:

1. An orthodontic device for repositioning teeth, comprising:
an integral piece of orthodontic appliance defining a target tooth arrangement and having at least a reinforcement portion and a shell portion, wherein:
the orthodontic appliance is configured to hug a plurality of teeth and resiliently reposition the plurality of teeth from a current tooth arrangement to the target tooth arrangement gradually within an extended duration of time;
the reinforcement portion has a first stiffness level; and
the shell portion is extended from the reinforcement portion and has a second stiffness level, the second stiffness level lower than the first stiffness level.

2. The orthodontic device of claim 1, the integral piece of orthodontic appliance further comprising:
one or more openings, each opening being surrounded by at least one of the reinforcement portion and the shell portion, wherein the orthodontic appliance is configured to expose part of the plurality of teeth to an oral environment via the respective opening and allow water to circulate through the respective opening.

3. The orthodontic device of claim 1, the integral piece of orthodontic appliance further comprising one or more slits formed on the shell portion, wherein the one or more slits are configured to modify the second stiffness level locally around the one or more slits.

4. The orthodontic device of claim 1, the integral piece of orthodontic appliance further comprising an attachment structure configured to grab a surface of a first tooth and apply a force on the surface of the first tooth along a shear direction tangent to the surface of the first tooth.

5. The orthodontic device of claim 4, wherein the attachment structure includes a plurality of attachment teeth on a micron level, and a surface of the plurality of attachment teeth of the attachment structures is porous on a nanometer level.

6. The orthodontic device of claim 4, wherein the attachment structure is attached to an internal surface of one of the reinforcement portion and the shell portion and configured to be in contact with a respective subset of teeth when be in contact with a respective subset of teeth when the orthodontic appliance is worn to hug the plurality of teeth.

7. The orthodontic device of claim 4, wherein the attachment structure extends from, and includes the same type of material as, a body of the reinforcement portion or the shell portion.

8. The orthodontic device of claim 4, wherein the attachment structure includes a first attachment structure, and is physically coupled to a second attachment structure via one of the reinforcement portion and the shell portion.

9. The orthodontic device of claim 4, wherein the reinforcement portion has an extended arm and the attachment structure is located at a tip area of the extended arm.

10. The orthodontic device of claim 4, wherein the attachment structure includes a first attachment structure, and the surface of the first tooth includes a first surface, the integral piece of orthodontic appliance further comprising:
a second attachment structure configured to grab a second surface of the first tooth opposite to the first surface on the first tooth;
wherein the second attachment structure is configured to apply a second pull force on the second surface of the first tooth along a second shear direction tangent to the second surface of the first tooth, the first and second pull forces configured to rotate the first tooth gradually within the extended duration of time.

11. The orthodontic device of claim 4, wherein the attachment structure includes a first attachment structure, the integral piece of orthodontic appliance further comprising:
a second attachment structure configured to grab a surface of a second tooth immediately adjacent to the first tooth, both the first and second attachment structures extending from the reinforcement portion and configured to pull the first and second teeth towards each other.

12. The orthodontic device of claim 1, wherein the reinforcement portion and the shell portion include a first appliance material, and the reinforcement portion has a first thickness greater than a second thickness of the shell portion.

13. The orthodontic device of claim 1, wherein the reinforcement portion includes a first appliance material, and the shell portion includes a second appliance material distinct from the first appliance material.

14. The orthodontic device of claim 1, wherein:
the reinforcement portion is configured to be aligned with and come into contact with a first tooth when the orthodontic appliance is worn to hug the plurality of teeth;
the reinforcement portion is located at a first position on the integral piece of orthodontic appliance; and
the first position and first stiffness level are configured to generate a force applied onto the first tooth, thereby facilitating repositioning of the plurality of teeth from the current tooth arrangement to the target tooth arrangement.

15. The orthodontic device of claim 1, wherein:
the reinforcement portion has a first area;
the shell portion has a second area that is larger than the first area; and
the shell portion at least partially overlaps the reinforcement portion.

16. The orthodontic device of claim 15, wherein the shell portion entirely overlaps the reinforcement portion, and the reinforcement portion is configured to be in contact with a respective subset of teeth when the orthodontic appliance is worn to hug the plurality of teeth.

17. The orthodontic device of claim 15, wherein the shell portion entirely overlaps the reinforcement portion, and the reinforcement portion is configured to be separate from the plurality of teeth by the shell portion when the orthodontic appliance is worn to hug the plurality of teeth.

18. The orthodontic device of claim 1, wherein the reinforcement portion includes one or more of: a solid piece, a skeleton having a plurality of ribs, a frame, a grid, and a ring.

19. The orthodontic device of claim 1, wherein a polygonal structure is attached to a surface of one of the plurality of teeth and has a plurality of receiving surfaces substantially perpendicular to the surface of the one of the plurality of teeth, the integral piece of orthodontic appliance further comprising:
one or more attachment structures each of which is configured to grab, and apply a pull or push force on, a respective one of the plurality of receiving surfaces of the polygonal structure.

20. The orthodontic device of claim 1, the integral piece of orthodontic appliance further comprising at least one of:
an actuator coupled to an external surface of the reinforcement or shell portion, the actuator configured to create a stimulus applied onto a subset of the plurality of teeth; and
a sensor, the sensor attached to an interface surface or an external surface of the orthodontic appliance and configured to monitor a characteristic of the plurality of teeth.
